(19) United States
(12) Patent Application Publication
(10) Pub. No.: US 2003/0200165 A1
(43) Pub. Date: Oct. 23, 2003

(54) Method and computer system for administering investments made by an investor

(76) Inventors: Jens Perch Nielsen, Gentofte (DK); Montserrat Guillen, Barcelona (ES); Mogens Andersen, Allerod (DK); Knud Bitsch Lauritzen, Hellerup (DK); Klaus Berentzen, Farum (DK)

Correspondence Address: HARNESS, DICKEY & PIERCE, P.L.C., P.O. BOX 8910, RESTON, VA, 20195, US

(21) Appl. No.: 10/284,369

(22) Filed: Oct. 31, 2002

Related U.S. Application Data
(60) Provisional application No. 60/366,248, filed on Mar. 22, 2002.

(30) Foreign Application Priority Data
Oct. 31, 2001 (DK) PA 2001 01609
Sep. 16, 2002 (DK) PA 2002 01363

(51) Int. Cl. G06F 17/60

(52) U.S. Cl. 705/36

(57) ABSTRACT

A data processing system, such as a computer system, for administering at least one individual account, at least one redistribution account and a risk taker account, each redistribution account being linked to an individual account and to the risk taker account, said accounts being preferably represented in the computer system as one or more account databases, and said administering being controlled by events, preferably being stored in and retrieved from an event database storing instances of events; said events effecting money transfers between the accounts preferably by entering and/or altering records in the account databases, said system comprising an event catalogue, preferably in the form of a database, storing transaction rules for money transfer between said accounts; to each event being assigned, if existing, a specific transaction rule for the case that event occur real time and a specific rule for the case the event occur at the end of a considered time window; processor means for retrieving from the event database events instances occurred within a particular time window and for, based on the retrieved events instances, identifying the affected rules; processor means for executing the affected rules in accordance with theirs possible mutual dependency thereby depositing an investor's investments on an individual account and/or transferring an amount between the redistribution account and the individual account and/or transferring the amount of the redistribution account to the risk taker in accordance with the events occurred within the time window considered.

The present invention relates inter alia to a data processing system, such as a computer system, for administering at least one individual account, at least one redistribution account and a risk taker account, each redistribution account being linked to an individual account and to the risk taker account, said accounts being preferably represented in the computer system as data storages, and said administering being preferably controlled by events initiating money transfers between the accounts administered by the data processing system.

The present invention also relates inter alia to a computerised method for administering investments made by an investor, said method is preferably controlled by events initiating money transfers between at least one individual account and at least one redistribution account linked to the individual account, and between a risk taker account, linked to the redistribution account(s), and the at least one redistribution account, wherein said accounts being preferably represented in a computer system as data storages

Today, the insurance market is dominated by two main type of products on the insurance market, namely the so-called Unit Linked products and more traditional products. These products have advantages as well as disadvantages but a common feature for these products is that they are easy to administer for an administrator but the risk involved in these products are less transparent.

Unit Linked products are in general characterised in that the return simply equals the return of some underlying investment and, often, a Unit Linked product is combined with some kind of guarantee limiting the losses when the underlying investment fund have very negative returns. In the latter situation the Unit Linked product needs some risk taker giving the guarantee.

The group of traditional products is in general characterised in that the return is based on the status of some bonus fund and the individual customers account. Most often these products are connected to some kind of guarantee limiting how low the return can be.

While Unit Linked policies are popular among investors world wide, there is some hesitation towards using this type of product as a general tool for occupational pension schemes. This is due to the risk involved in Unit Linked products, namely the risk stemming from the underlying investment strategy and secondly the risk that returns are not smoothed, leaving the customer to the full impact of volatile markets. Traditionally average return products have been used to eliminate these two risk factors. Firstly the underlying investment policy is determined by the insurance company eliminating the most risky strategies, secondly market volatility is smoothed over a period and thirdly an underlying guarantee is often a part of this type of product. The European experience during the last twenty years of the last century, where actuaries did not anticipate the rapid and continued decline of interest rates, has shown that the old type of average return products need to be modified. There has been expressed a reasonable doubt about the ability of the Life and Pension industry to live up to the given promises and the conventional products are often organised in a way that is obscure to both the customer and the expert. Most people do not know what happens to their money leaving customers unsatisfied, often even in situations where their returns outperform the market substantially. Furthermore, modern customers seem to demand more insight into the details of their returns. This seems to be one of the most important reasons for the popularity of Unit Linked products, the customer understands the link between his return and the return on the underlying assets. However, recent studies have indicated that a number of real-life Unit Linked strategies suffers from irrational trading patterns.

Thus, an overall object of preferred embodiments of the present invention is to provide a pension method and product which possess the transparency of Unit Linked products and the safety of older average return products. Additionally and importantly, another object of the present invention is provide the method and the product so that they are susceptible to be computerised as the method and product in order to be commercially beneficial preferably should be able to deal with a large number of clients (investors).

In accordance with the objects of the present invention different aspects of the present invention embodies a transaction scheme which, of course, is considered to be an invention in it self, and which comprises the steps of:

depositing the investor's investments on an individual account,

transferring return of the individual investor account to a redistribution account,

transferring a proportion of the redistribution account to the individual investor account, the proportion being preferably a function of the amount of the redistribution account,

and transferring the amount of the redistribution account to a risk taker when a predetermined event occurs.

In accordance with the present invention a transparent average return product with a risk and return performance superior to traditional Unit Linked products has been constructed. This superiority may for instance be measured as the performance of four quantiles in a simulated illustration of the method and the data processing system according to the present invention, namely the upper 90% quantile, the median and the lower 5% and 1% quantiles. A new component of this new type of products is a so called redistribution account. This account belongs partly to a customer and partly to a risk taker. Particular rules specify how the redistribution account is divided between the customer and the risk taker. So, while both traditional products and Unit Linked products with guarantees have individual accounts and a risk taker, then the present invention in addition has a redistribution account. It has been realised that this redistribution account increases flexibility and enables the construction of safe and transparent products. Furthermore, it has been realised that risk management in a particular preferred embodiment of the present invention is dramatically simplified when compared to risk management in prior art products. This is another clear advantage of transparent products, namely that transparent products are also easier to analyse from a risk management point of view than less transparent products.

The same economical effect as provided by the present invention may, at least theoretically, be obtained by a method not comprising a redistribution account but comprising the steps of keeping track of all interests during the term of e.g. a pension. However, such a method would require an enormous amount of data storage, storing a large number of intermediate transactions, and computer capacity for processing the intermediate transactions in order for such a method to be industrial applicable. As indicated above, an aim of the present invention was to provide a feasible computer implemented system, that is a system being industrial applicable, robust and efficient. Furthermore, the system should preferably be adapted to perform the transactions involved and to keep track of all the short term investments. Typically and preferably, the computer system must be adapted to do this job for typically 30.000-100.000 or more clients over typically 30 years, and a system not benefiting from the redistribution account would most certainly demand a huge data storage capacity as well as huge processor capacity to process all the financial data in order to determine the total interest for each individual. The demand for huge processor capacity will most certainly be emphasised by a demand from the risk taker asking, typically on a monthly basis, on the status of the total interests.

Thus, the way of keeping track of all interests does not seem technical appropriate. However, introduction of the redistribution account has been found to render the overall concept of the present invention susceptible to computerised calculation.

In accordance with the present invention, a pension or investment customer's risk profile is optimised by letting a risk taker smooth returns on investments. It is envisaged that the risk taker will have a profit most of the time, but with a significant possibility of a loss. The smoothing of the returns has the effect of lowering the downside investment risk at the cost of opportunities of excessive upsides.

As indicated above, an object of the present invention is to provide a method susceptible to be computerised. In this connection it has been realised that implementation of the present invention as a data processing system and/or a computerised method required a solution of a number of additional technical problems, especially when considering administration of the pensions. In addition to this, an object of the invention is to provide a sufficiently flexible computerised implementation so as to allow for a broad range of investment products with the above discussed characteristics.

As an example, an aim of preferred embodiments of the present invention is that such embodiments should be able to administer transactions in accordance with transaction rules according to the present invention for a large number of clients. These transaction rules are in order to render the invention susceptible to computerised execution preferably defined to be instantiated by events. However, such events are typically and preferably characterised by some of them occurring at a regular basis, typically being predefined, whereas a significant number of them occur at a random basis, typically resulting in that further technical considerations should be made before design of a computer system to operate efficiently on the basis of such a combination of regularly and randomly occurring events can be completed and programming can start. This aspect is even more pronounced as the transaction rules may or may not have an inherent and mutual dependency claiming a specific execution sequence of two or more rules, and that one or more specific event may overrule all other transaction rules. As will appear from the following, an appreciable technical feature of preferred embodiments of the present invention is the event catalogue storing in a computer system rules for money transfers between the different accounts involved. Preferably and typically, in such an event catalogue the inherent and mutual dependency between the rules are made up prior to application of the rules and the action(s) needed to be performed by the computer system in response to one or more events occurring may easily be derived during application of the rules by looking-up in the event catalogue. As a consequence, the otherwise time consuming programming of the mutual dependency between the rules is dispensed with and as a further and very important effect, changes to the rules and/or theirs mutual dependency may easily be altered by altering the content of the event catalogue resulting in a system being easily adaptable.

On the basis of the different objects and aims of the present invention, preferred embodiments according to a first aspect thereof relates to a data processing system, such as a computer system, for administering at least one individual account, at least one redistribution account and a risk taker account, each redistribution account being linked to an individual account and to the risk taker account, said accounts being preferably represented in the computer system as one or more account databases, and said administering being controlled by events, preferably being stored in and retrieved from an event database storing instances of events; said events effecting money transfers between the accounts preferably by entering and/or altering records in the account databases, said system comprising:

an event catalogue, preferably in the form of a database, storing transaction rules for money transfers between said accounts; to each event being assigned, if existing, a specific transaction rule for the case the event occur real time and a specific rule for the case the event occur at the end of a considered time window; processor means for retrieving from the event database events instances occurred within a particular time window and for, based on the retrieved events instances, identifying the affected rules;

processor means for executing the affected rules in accordance with theirs possible mutual dependency thereby depositing an investor's investments on an individual account and/or transferring an amount between the redistribution account and the individual account and/or transferring the amount of the redistribution account to the risk taker in accordance with the events occurred within the time window considered.

In the present context, there has at a number of occurrences been distinguished between “event” and “event instance”. While “event” has been used to designate a particular kind event such as Premium, Benefits etc. “event instance” has been used to designate a particular instance of an event. For example, an event may be “Premium” and the event instance of Premium may be “Premium; Mr. Hansen; 200 US$, Jan. 1, 2003”.

In this noted that a transaction rule may include a rule dictating that no action is to be performed on the basis of the event.

Depositing and transferring are performed by means preferably being one or more central processing units of a computer system. Such means is(are) preferably instructed to perform calculations and/or extract and/or store data in data storage.

In general, the computer system is considered to comprise means for performing a number of steps. These means is/are preferably processor means such as one or more central processing units preferably being adapted perform one or more step by processor readable instructions. Depending on the actual configuration of the computer system, such central processing units may be a single unit instructed to perform all the necessary actions or the may be a number of units each being instructed to perform its own specific step and to co-operate with the other units of the system. These units may comprise or co-operate with storage means in the form of discs, ram, rom and the like.

In order to distinguish between different types of events and thereby ease handling of actions related to occurrence of events, it is preferred that that events are grouped into administration type events being selected from the group of types consisting of key business type events (being events which occur at a non-predefined time) and regular type events (being events occurring at predefined instants) and grouped into termination events being events terminating the administering of the accounts.

Such events are in particularly preferred embodiments of the invention stored and in such embodiments, the data processing system further comprise event storage means storing preferably in the event database each event that has occurred and the time each event occurred in a time window.

In general, transactions performed on the accounts involved in the present invention and other transactions performed are effectuated by events and to each event one or more transaction rule is preferably assigned. In such embodiments, the data processing system according to present invention event catalogue is storing or further storing an event catalogue comprising transactions rules as function of account and event.

Typically, the rules corresponding to events should be executed in the order the events occurred, but in some situations, two or more events occur at the same time—or is said to occur at the same time. Furthermore, or alternatively, one or more rules are dictated to be executed before other rules even though the time sequence of the events corresponding to the rules dictates another execution order. In such an similar situations, the mutual dependency between rules stored in event catalogue preferably is stored as a sequence number for each transaction rule selected to have a sequence number assigned, said sequence number dictating a particular sequence for executing rules in case an event results in execution of more than one rule and/or in case two or more events occur simultaneously so that more than one rule are to be executed. In preferred embodiments of the invention, all transaction rules stored in the event catalogue storage means are selected to have a sequence number assigned.

In particular preferred embodiment of the invention, the data processing system comprises processor means, preferably being adapted to

establish, preferably by reading from a data storage, begin and end time (T_{begin}; T_{end}) of a processing time window in which processing of events instances is to be performed;

establish, preferably by reading from the event database, events instances that have occurred, if any, and which relates to rules to be executed, and the time the events occurred within said processing time window;

execute the rules corresponding to the established events instances, if any, in the order defined by the sequence number of the rules and/or in succession by the time the established events occurred.

Thus, during processing of events a time period is considered and the events occurred in this time period are extracted from a storage. Based on these extracted events the event catalogue is consulted to look up any rules to be executed and if it is found that some rules are to executed these rules are executed in the order defined by the sequence number and/or by the time the events occurred. The time window considered is typically specified by the administrator of the data processing system.

Preferably and advantageously, the processing means of the data processing system according to the present invention is(are) further adapted to

step through the processing time windows with a predetermined time increment, dT, thereby defining time spots in the processing time window;

establish, at each time spot, preferably by reading from the event database means, events occurred, if any, in a time frame defined by the latest time spot considered and the time spot in question; and

at each time spot to execute rules corresponding to the established events, if any, in the order defined by the sequence number of the rules to be executed.

This aspect of the data processing system may preferably be combined with adapting the event processing means to treat two or more events as having occurred simultaneously in case said two or more events occur within a time frame defined by the latest time spot considered and a time spot in question, whereby the continuous time history of the processing windows are broken up into a discrete representation of the event history thereby rendering the invention further susceptible to computerisation.

Easy track-keeping of event processing is rendered possible in particular preferred embodiments of the invention, wherein said event processing means further is adapted to check mark an event instance when the rule(s) corresponding to the event instance(s) has(have) been executed.

Preferably, the event processing means further being adapted to

read, preferably during execution of a transaction rule, from one or more storage a basis for the transaction rule, such as read from the event catalogue the variable(s) being involved in execution of the transaction rule, such as a rate of return, and reading from another storage the value(s) of the variable(s);

manipulate, during execution of a transaction rule, the basis for the calculation(s) in accordance with the transaction rule thereby determining one or more amount to credited and/or debited on one or more account(s); and

during execution of a transaction rule, debit and/or to credit the amounts determined in accordance with the transaction rule.

In order to ease keeping track of the debiting and crediting performed by the data processing system according to present invention, the processing means is(are) preferably further adapted to obtain and maintain a log file storing all debiting and crediting performed. Thereby, for instance errors in the crediting/debiting may be traced and corrected.

Preferably, the check marking of an event is done after all crediting and/or debiting effectuated by the events have been performed, whereby it has been rendered easy to check whether events has been processed.

Furthermore, the data processing system according to the present invention may further preferably comprise an event processing information storage, and the event processing means is(are) preferably further adapted to store in said event processing storage the begin time and end time of a time window after events occurred within said time window have been processed, thereby rendering it easy to check whether processing of events in time windows has been successful.

In order to increase the flexibility of the data processing system according to present invention, the system may further comprise a product information storage storing information on product characteristics, such as percentage of the redistribution account to be transferred to the individual account, such as number of benefits to be transferred to be disbursed to the investor, parameters for cost calculations and the like.

This product information storage may preferably and advantageously be combined with adapting the system to read from the product information storage some or all value(s) of the variable(s) of the basis of the calculations.

The data processing system according to the present invention may preferably further comprise an investor agreement information storage storing for each of a plurality of investors information on a particular product assigned to a particular investor. In such embodiments the data processing system is adapted to, before initiation of event processing for a particular investor, read from the investor agreement information storage information on the particular product assigned to the particular investor so that the event processing for a particular investor is based upon the product assigned to said particular investor. With such a system it has been rendered very easy to administer a plurality of investors' investments in an individual manner as processing events for an individual can be based on the extracting information from the investor agreement information storage.

The data processing system according to present invention may preferably further comprise an individual event information storage storing for each investor all events that are related thereto, so as to render administration of several investors investments easy by letting the data processing system having easy access to the information on events relevant for each investor.

Preferably the data processing system according to the present invention may also comprise a common event information storage storing events being common for all investors whereby all events for all products are easy accessible to the data processing system.

The representation of the individual account(s), the redistribution account(s) and the risk taker account in the data processing system according to the present invention comprises preferably records in a data base on debit and credit transactions made on the accounts.

Preferably, the data processing system according to invention is adapted to determine the balances of the individual account(s), the redistribution account(s) and the risk taker account by summing all the transactions made on the accounts.

The data processing system according to the invention, may preferably further comprise an individual transaction account in the form of a storage linked to each individual account of the data processing system. Such individual transaction account records all transactions made between the investor and the administrator, such as all premiums paid by the investor and all benefits the administrator is disbursing.

In this situation the data processing system according to the invention is preferably adapted to determine the balance of the individual transaction account by summing all transactions made on the account.

Preferably, the data processing system according to present invention may further comprise an investment fund account represented as a data storage storing records on investments made in underlying assets of the amounts of the individual account(s), the redistribution account(s) and the risk taker account. Such records comprises preferably identification of the financial instruments invested in, trading information and/or market value.

The data processing system according to present invention may preferably further comprise an investment performance information storage storing information on the performance of the investments made in the underlying assets of the amounts of the individual account(s), the redistribution account(s) and the risk taker account. The information stored comprises preferably the returns of the investments made, expected returns of the investments made and/or interest rates.

In a preferred embodiment of the present invention the data processing system comprises a plurality of individual accounts, a redistribution account linked to each individual account and one risk taker account linked to the plurality of individual accounts and the redistribution accounts.

In a second aspect of the present invention a computerised method for administering investments made by an investor is provided. This method is controlled by events initiating money transfers between at least one individual account and at least one redistribution account linked to the individual account, and between a risk taker account, linked to the redistribution account(s), and the at least one redistribution account. These account being represented in a computer system as data storages

The method comprising preferably performing the following steps in a computer:

depositing the investor's investments on an individual account when an administration type event occur,

transferring an amount between the redistribution account and the individual account when an administration type event occur, and

transferring the amount of the redistribution account to a risk taker account when a termination type event occurs.

It is to be noted, that the above categorisation of events into administration type event and termination type event reflects preferred embodiments and that the categorisation in such embodiments merely reflect that termination of the administering is defined to occur when a special type of event occur. Of course, the occurrence of such a termination type event may be inherent in the administering as a time to maturity of the adminstering.

The investor's investments are preferably invested in underlying assets and alternatively or in addition thereto is the amount of the redistribution account invested in underlying assets.

Preferably, each of the at least one individual account is assigned to, such as owned solely by, the individual and each of the at least one redistribution account is assigned to, such as owned solely by, the individual and/or the risk taker.

Furthermore, it is preferred that the risk taker account is assigned to, such as owned solely by, a risk taker, which risk taker is preferably a different entity than the individual, such as second investor.

Preferably, the risk taker account is assigned to a plurality of redistribution accounts.

According to the method according to the present invention, the step of transferring an amount between the individual account and the redistribution account may preferably comprise the steps of transferring

from the individual account a return of the individual account to the redistribution account, and transferring

from the redistribution account an amount equal a modified return of the individual account to the individual account.

Furthermore, the step of transferring an amount between the individual account and the redistribution account may preferably comprise the steps of

determining the difference between a return of the individual account and a modified return of the individual account and

transferring this difference between the individual account and the redistribution account.

Preferably, the return is determined on the basis of the amount present on the individual account before one or more administration events occur effecting one or more transfers from and to the individual account.

Furthermore, the step of transferring an amount between the individual account and the redistribution account may preferably further comprise the step of transferring a proportion of the amount of the redistribution account to the individual account. This proportion is preferably determined on the basis of the amount present on the redistribution account before one or more administration events occur effecting transfers from and to the redistribution account and to the individual account.

According to preferred embodiments of the method the amount of the redistribution account, of which the proportion is taken, is preferably the amount present on the redistribution account before the return of the individual account is transferred to the redistribution account and before the modified return is transferred from the redistribution account and to the individual account.

Alternatively or in combination thereto, the proportion is preferably determined on the basis of the amount present on the redistribution account after one or more administration events have occurred having effected transfers from and to the redistribution account and to the individual account.

According to preferred embodiments of the method, the amount of the redistribution account, of which the proportion is taken, is preferably the amount present on the redistribution account after the return of the individual account is transferred to the redistribution account and after the modified return is transferred from the redistribution account and to the individual account.

Preferably, the proportion is a fraction of the amount on the redistribution account, which fraction depends, preferably, in general on the past financial scenarios. In particular embodiments, the fraction is constant, such as substantially constant, during one or more time periods, such as constant during the duration of a contract made between the investor and the administrator of the method. Preferably, the fraction is smaller than 1.

In preferred embodiments of the invention the method may further comprise the step of ceiling the transfer from redistribution account to the individual account. Preferably, such as ceiling is determined by bounding the proportion transferred from the redistribution account to the individual account.

The method according to the present invention may preferably further comprise the step of determining the fraction by a functional relationship securing a guaranteed return on the individual account.

Such a step securing of a guaranteed return is typically and preferably accompanied by determining the fraction by the functional relationship, providing a decreasing fraction when the amount on the redistribution account becomes smaller than a predefined amount. This may preferably by accompanied by letting the functional relationship determines the fraction, α, so that it increases when the amount on the redistribution account becomes larger than a predefined amount.

According to particular preferred embodiments of method, the transfers between the redistribution account and the risk taker account is not limited to situation where a termination event occur, as the method may preferably further comprise the step of transferring an amount of the redistribution account to the risk taker account when an administration event occur. Preferably, the amount of the redistribution account to be transferred to the risk taker account is set according to a contract made between the investor and the administrator.

Furthermore, the method according to present invention may further comprise the step of determining a pay out amount of the individual account and transferring this pay out amount to the investor assigned to the individual account.

In particular preferred embodiments wherein the method is applied for administering products such as life annuities, the step of determining a pay out amount and transferring the amount to the investor is preferably only executed in a time period ending when a termination event occur. Preferably this time period is a last term of the duration of a contract made between the investor and the administrator of the method.

The method according to the present invention may advantageously operate in scenarios wherein the time when the termination event occur is deterministic as well in scenarios wherein the time when the termination event occur is stochastic.

Preferably, the method according to the present invention operates on administration type event which is selected from the group of types consisting of key business type event being events which occur at a non-predefined time and regular type event being events occurring at predefined instants.

The method according to the present invention may preferably further comprise the step of storing in an event storage means, preferably being a database, each event occurred in a time window and the time each event occurred.

In accordance with the present invention, the transfers between the account are preferably effectuated by processing events, which processing preferably comprises

establishing, preferably by reading from a data storage, begin and end time of a processing time window in which processing of events is to be performed;

establishing, preferably by reading from the event data storage means, events occurred within said processing time window, if any, and the time the events occurred within said processing time window and which relates to rules to be executed;

consulting an event catalogue storage means and establishing rules corresponding established events, if any; said event catalogue preferably being a database storing transactions rules as function of account and event and a sequence number for each transaction rule selected to have a sequence number assigned, said sequence number dictates a particular sequence for executing rules in case an event results in execution of more than one rule and/or in case two or more events occur simultaneously so that more than one rule are to be executed,

executing the established rules, if any, in the order defined by the sequence number of the rules and/or in succession by the time the established events occurred.

It is preferred that all transaction rules stored in the event catalogue storage means are selected to have a sequence number assigned, but embodiments where some or all transaction rules does not have a sequence number assigned is envisaged.

Preferably, the event processing of the method according to the present invention may further comprise

stepping through the processing time windows with a predetermined time increment, dT, thereby defining time spots in the processing time window;

establishing at each time spot, preferably by reading from the event data storage means, events occurred, if any, in a time frame defined by the latest time spot considered and the time spot in question; and

executing at each time spot rules corresponding to the established events, if any, in the order defined by the sequence number of the rules to be executed.

The method according to the present may preferably further comprise the step of defining two or more events to have occurred simultaneously in case said two or more events occur within a time frame defined by the latest time spot considered and a time spot in question.

Furthermore, the method may preferably further comprise the step of check marking an event when the rule(s) corresponding to the event has(have) been executed.

Advantageously, the step of executing a transaction rule according to the present invention may preferably further comprise the steps of

reading from one or more storages a basis for transaction rule, such as reading from the event catalogue storage means variable(s) being involved in execution of the transaction rule, such as a rate of return, and reading from another storage the value(s) of the variable(s);

manipulating the basis for the calculation(s) in accordance with the transaction rule thereby determining one or more amount to be credited and/or debited on one or more account; and

debiting and/or crediting the amounts determined in accordance with the transaction rule thereby effectuating a money transfer.

In preferred embodiments, the method according to the present invention further comprises the step of storing in a log file all debiting and crediting performed.

Preferably, the check marking of an event is done after all crediting and/or debiting effectuated by the event has(have) been performed.

The method according to the present invention may preferably further comprise storing in an event processing storage the begin time and end time of a time window after events occurred within said time window have been processed.

Preferably, the method according to the present invention may further comprising reading product information from a product information storage storing information on product characteristics, such as percentage of the redistribution account to be transferred to the individual account, such as number of benefits to be transferred and amounts to be disbursed to the investor, parameters for cost calculations and the like.

In such cases, some or all of the value(s) of the variable(s) of the basis of the calculations is(are) preferably read from the product information storage.

The method according to the present invention may preferably further comprise the step of reading from an investor agreement information storage information on the particular product assigned to the particular investor so that the event processing for a particular investor is based upon the product assigned to said particular investor, before initiation of event processing for a particular investor.

Preferably, all transactions made on the individual account(s), the redistribution account(s) and the risk taker account are stored as records in one or more data storage.

Preferably, the method according to the present invention may further comprise the step of determine the balances of the individual account(s), the redistribution account(s) and the risk taker account by summing all the transactions made on the accounts.

In the following preferred embodiments of the present invention will be described in details. The description is accompanied by the figures appended and briefly described below.

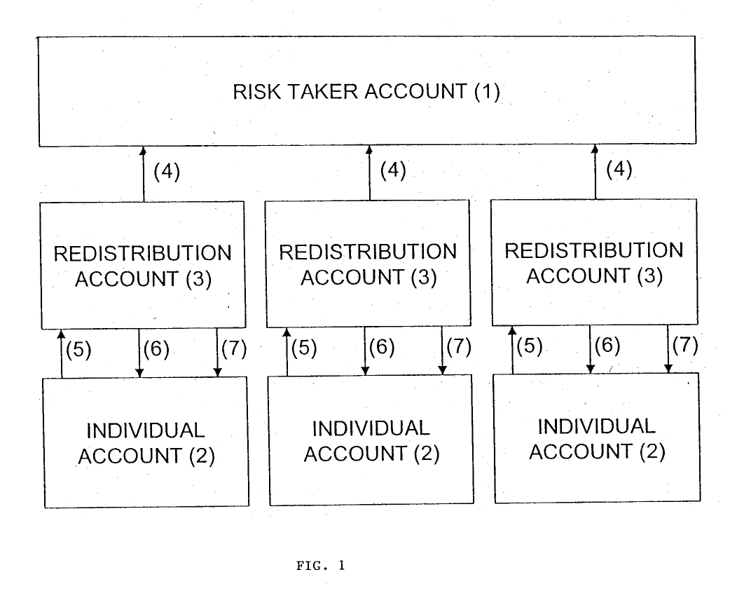

FIG. 1 shows an overall presentation according to the present invention,

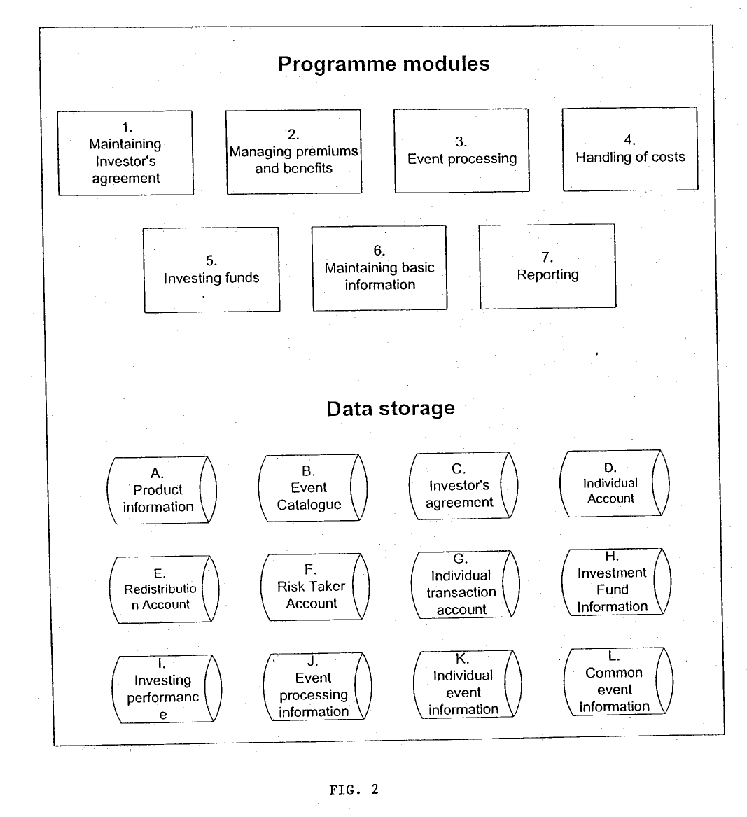

FIG. 2. shows a computer system according to the invention comprising programme modules and data storage.

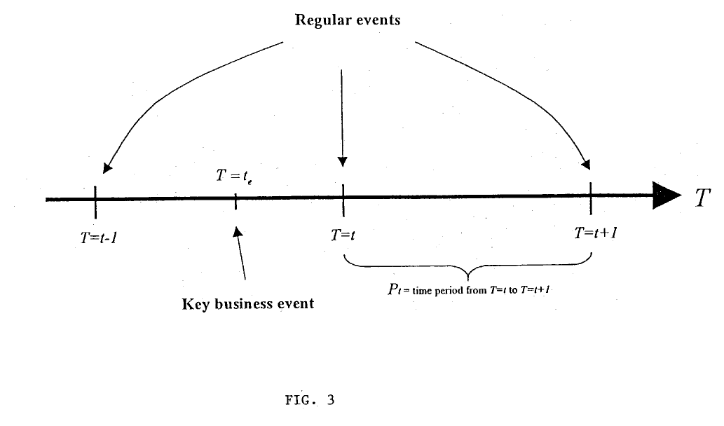

FIG. 3 shows a timeline with events indicated.

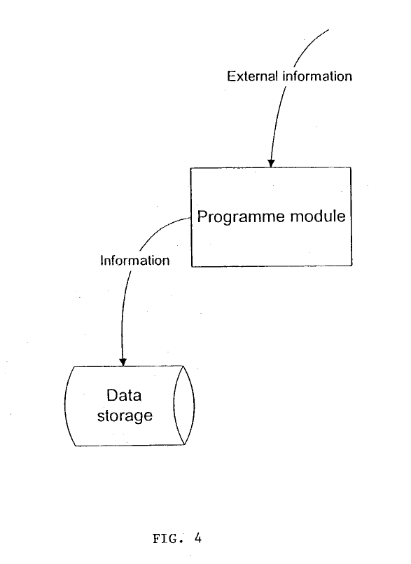

FIG. 4 shows a programme module writing information to a data storage.

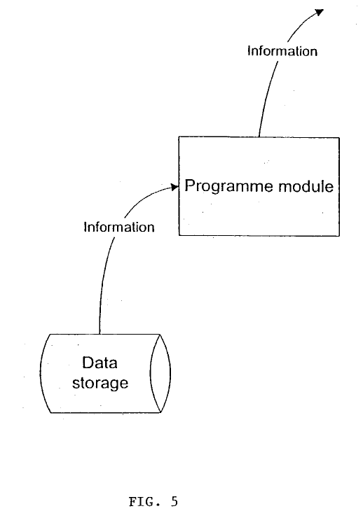

FIG. 5 shows a programme module reading information from a data storage.

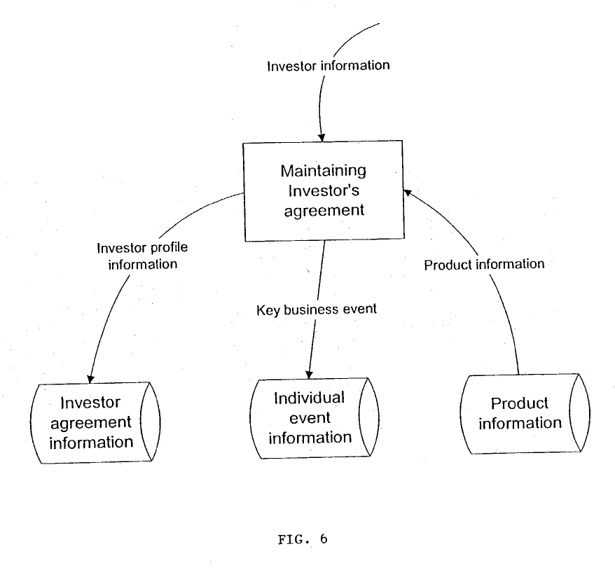

FIG. 6 shows that the module read information from product information and record information in investor agreement information and individual event information.

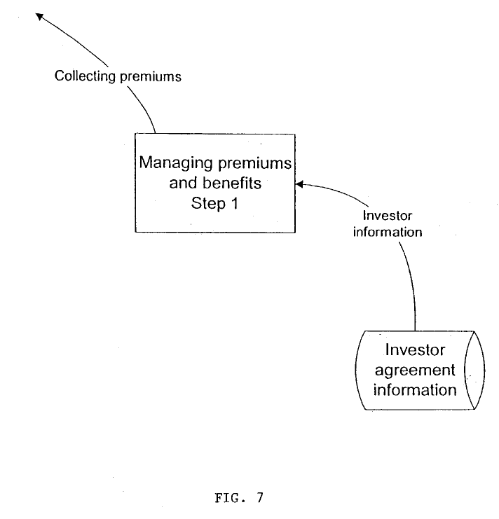

FIG. 7 shows collection of premiums.

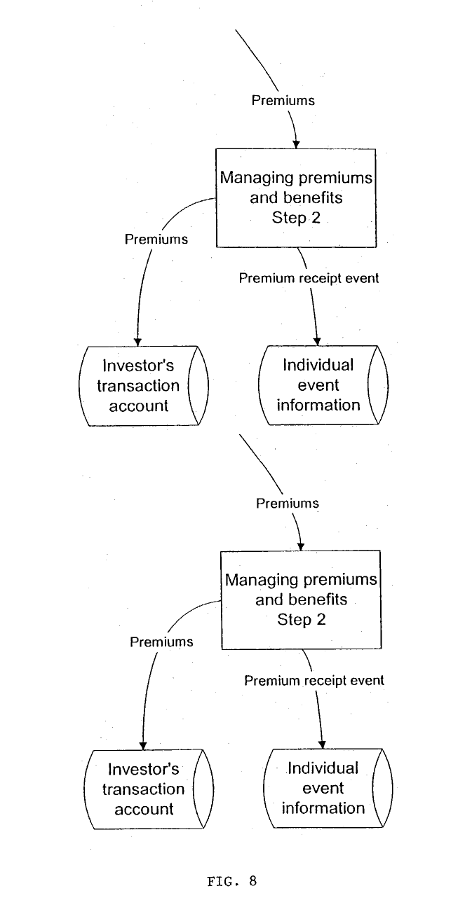

FIG. 8 shows receipt of premiums.

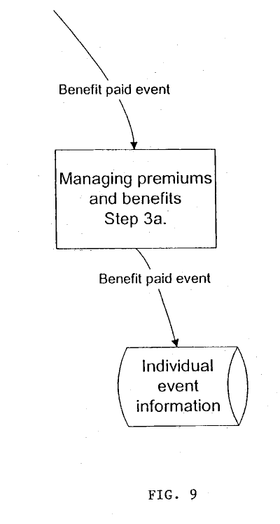

FIG. 9 shows update of benefit paid event.

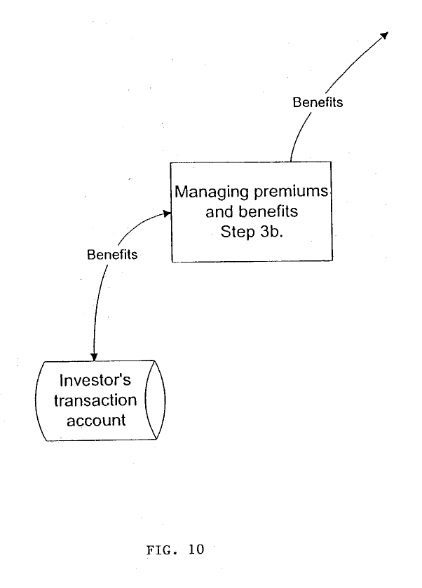

FIG. 10 shows payment of benefits.

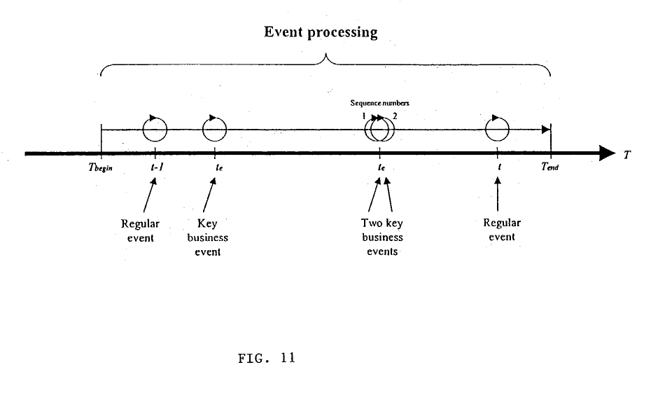

FIG. 11 illustrates that the programme module is processing all the events occurring in a certain period of time from T=Tbegin to T=Tend. This includes all types of events—the “regular events”, the “key business events” and the “termination events”. The events are processed in succession by the time they occur. If more than one event occurs at the same time the events are processed in succession by their related sequence number.

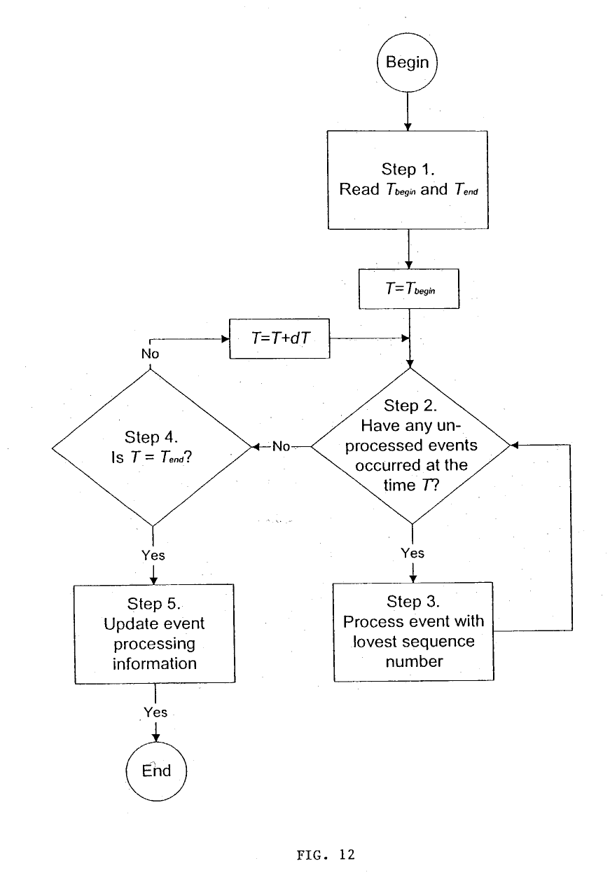

FIG. 12 shows the mechanism for processing all the events in the specified period of time

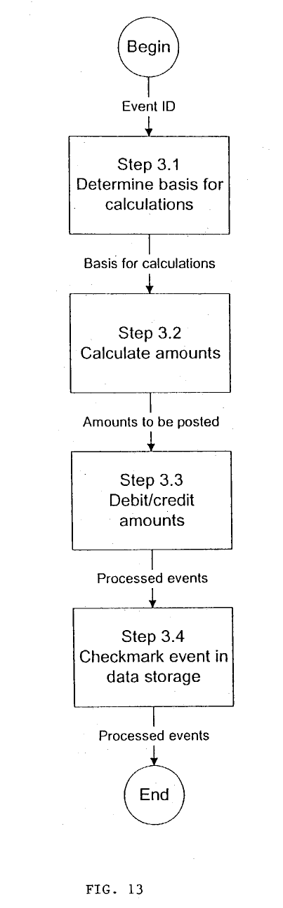

FIG. 13 shows the steps in the processing of the individual event.

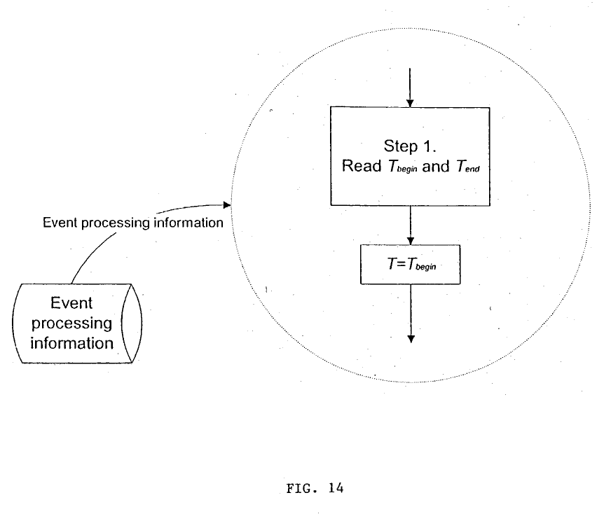

FIG. 14 shows that the time period for processing is extracted from the data storage for events processing information.

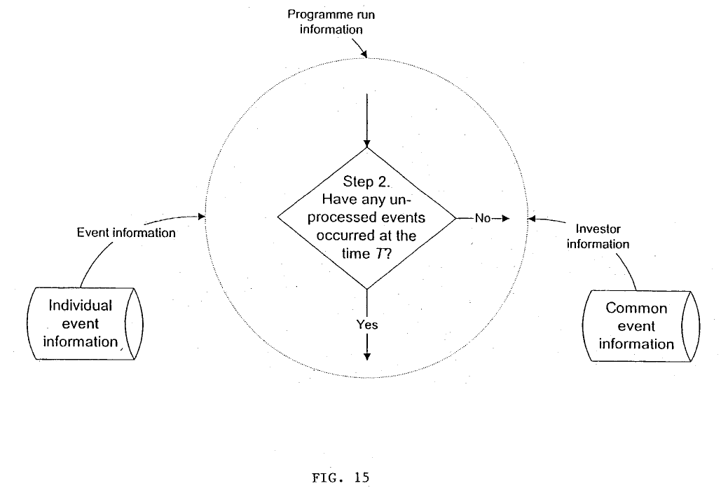

FIG. 15 shows that the step reads information from the data storage for individual and common event information.

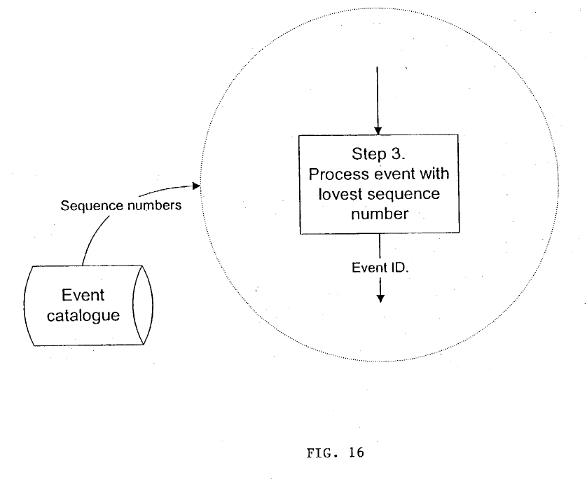

FIG. 16 shows that the step reads information from the event catalogue.

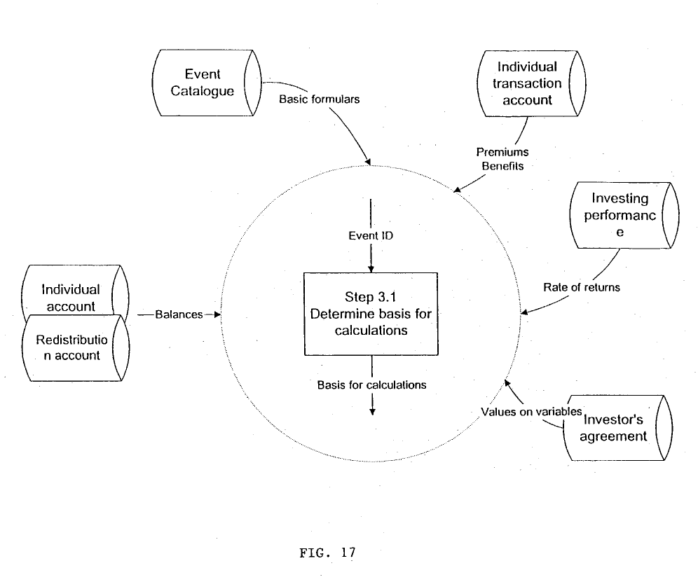

FIG. 17 shows that the step reads information from various data storage.

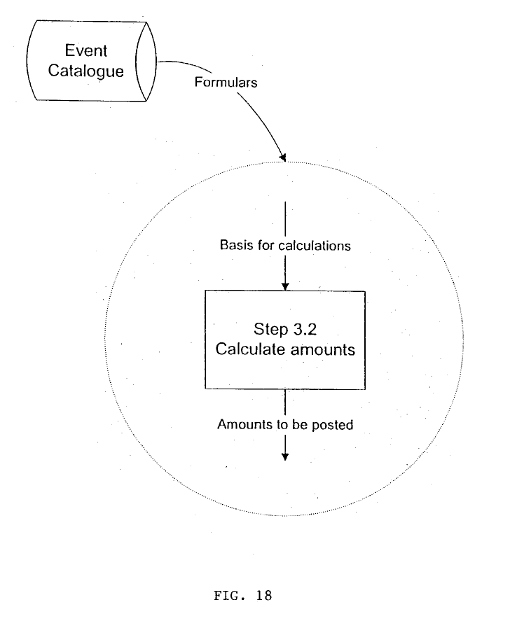

FIG. 18 shows that the step reads information from event catalogue to calculate the amounts.

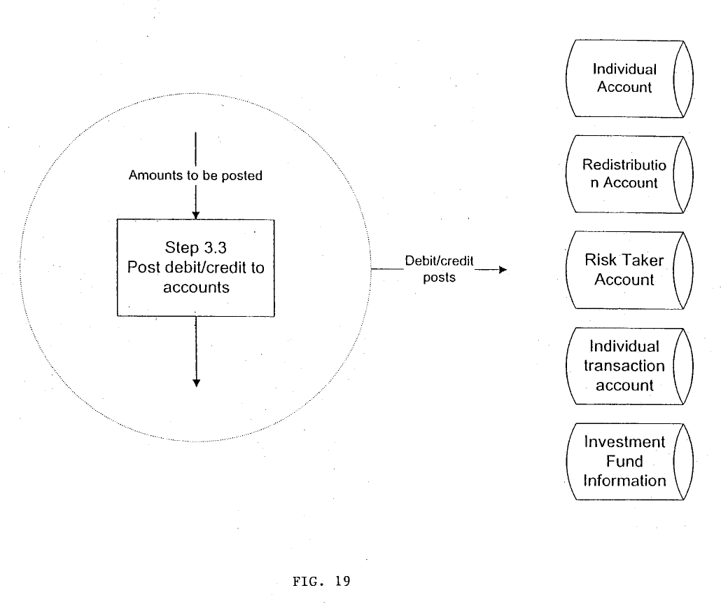

FIG. 19 shows the step writing the debit credit posts to the accounts.

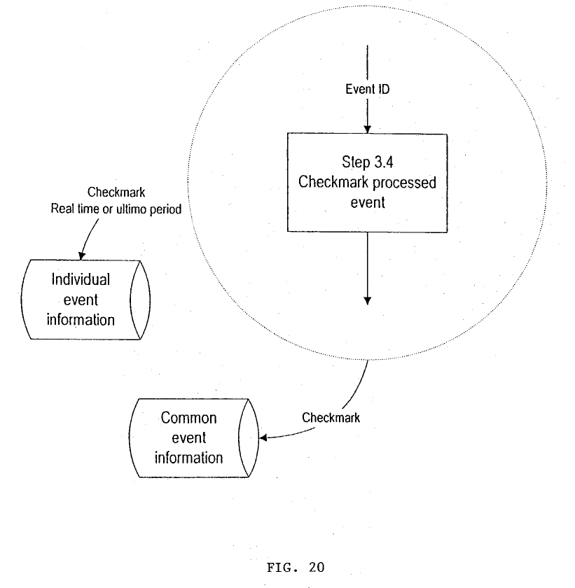

FIG. 20 shows the step which checkmarks the processed eventss.

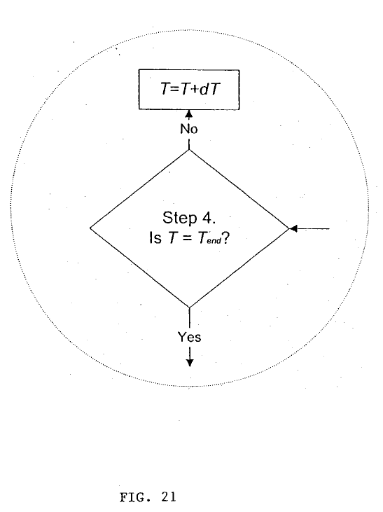

FIG. 21 shows the step concerning the decision whether the module has reach the end of the time period to process, T_{end}.

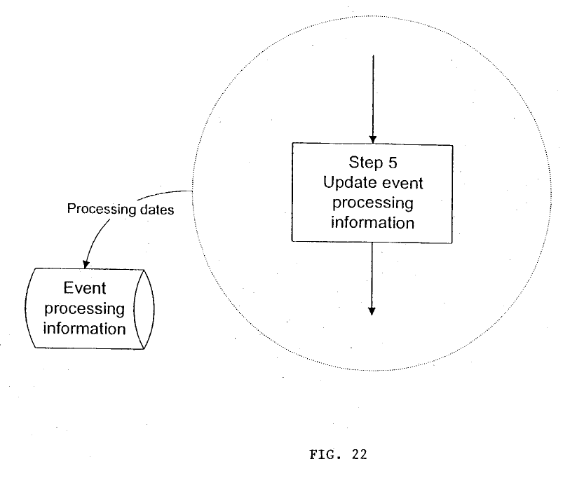

FIG. 22 shows the step writing the processed time period to the data storage for event processing information.

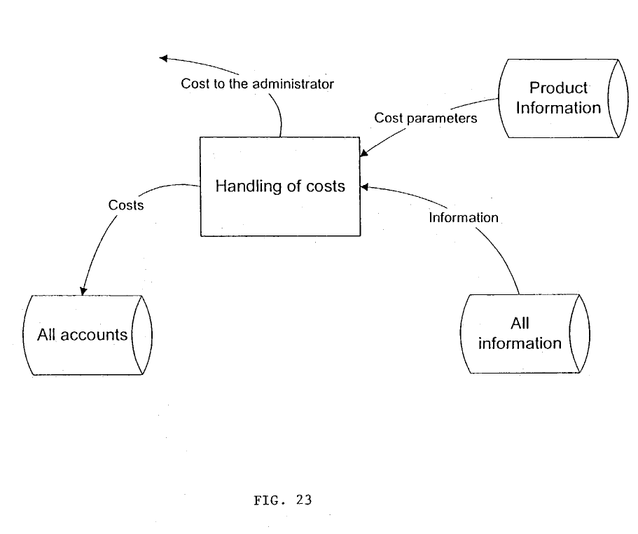

FIG. 23 shows handling of costs.

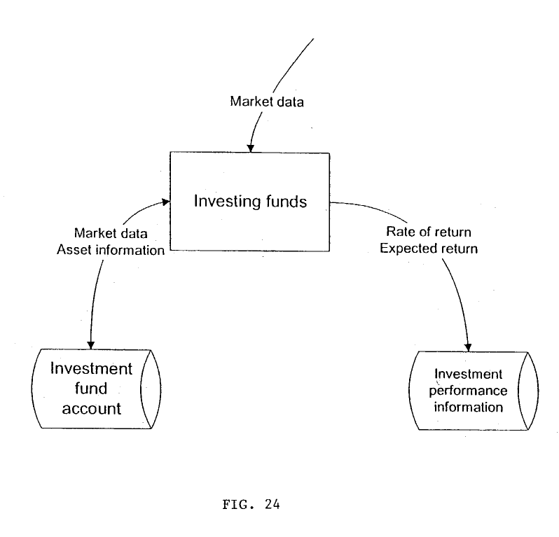

FIG. 24 shows the investing fund module.

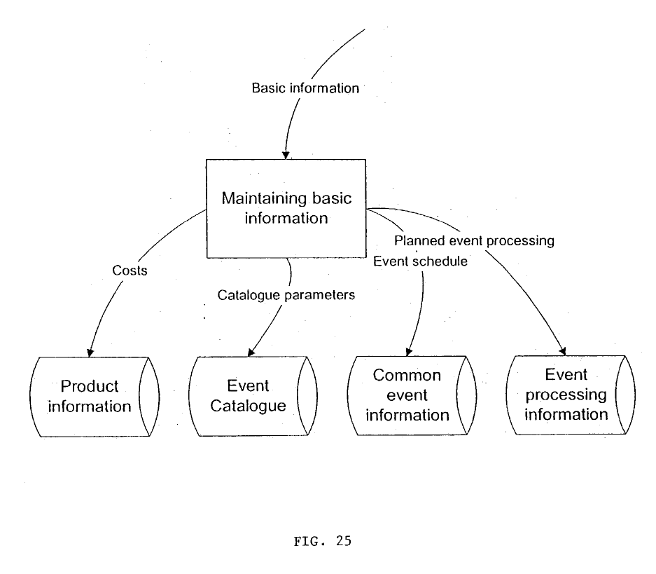

FIG. 25 shows the programme module updating various data storage.

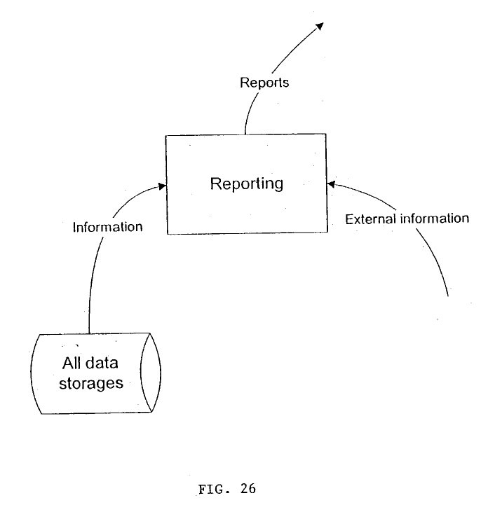

FIG. 26 shows the module for reporting potentially uses all the data storage for the reports.

With reference to FIG. 1 a preferred system according to the present invention comprises three accounts

a risk taker account 1,

at least one individual account 2, each one belonging to an individual, and

at least one redistribution account 3 preferably belonging to the risk taker or risk takers

All accounts are invested in some way, which can vary for three accounts 1, 2 or 3. They can be connected to an underlying fund or they can obtain returns in other ways.

Money transfer between the different accounts is governed by rules that will be described in details below, and according to these rules, money is transferred between the accounts as shown by the arrows 4-7 in FIG. 1. The arrows, even though shown in FIG. 1 to indicate transfer from one account to another, also indicates situations in which a negative amount is transferred which may be interpreted as transfer of money in the opposite direction than indicated by the arrow.

The arrow 4 describes money transfer from the redistribution account 3 to the risk taker account 1. The money transfer may also in this situation be negative which corresponds to transfer of money from the risk taker account 1 to the redistribution account 3. This money transfer will often, but not always, be a transfer of the entire redistribution account. According to the money transfer rules it is preferred that the money transfer is instantiated by events, but the transfer may, of course, occur periodically. The events will be described in details in the following sections. However, events could typically be insurance events e.g. disability, death or termination.

Arrow 5 describes money transfer from individual account 2 to the redistribution account 3. This transfer could typically be the return of the individually account 2 calculated according to the return on the underlying investments.

Arrow 6 and 7 describes money transfer from the redistribution account 3 to the individual account 2. The money transfer indicated by 6 may preferably be construed as a money transfer linked to the amount of the individual account 2. For instance, 6 could preferably be a return on the individual account 2 based on an externally given bond yield and 7 could preferably be a continued transfer of some part of the redistribution account 3 to the individual account 2.

In a preferred embodiment of the present invention, the transfer indicated by 7 happens according to a transfer rate a that could be a constant, e.g. 20%, or it could be variable depending on the accounts, the contract or other things. In such an embodiment, the money flow may be as disclosed in the following illustrative example. In all the illustrative examples below we have chosen that the individual account 2 and the redistribution account 3 are invested in the same underlying fund. While this is not necessary, it helps the presentation. The underlying fund is assumed to give the return rₜ for the time period from time t−1 to time t.

Illustrative Example 1a

In the following, a first embodiment of the system according to the present invention is presented with reference to FIG. 1, showing a risk taker account 1, a plurality individual account 2 and a plurality of redistribution account 3. Initially, i.e. at t=0 it is assumed, in order to ease understanding of the invention, that all the balances of the accounts are zero.

At t=0 an individual signs up a contract and deposits an amount of money, P₀, on his individual account 2. This amount having a value of D₀*, will be invested in underlying assets by the administrator of the system, and will at t=1, i.e. after a first period of time have produced a return of the order r₁. Furthermore, the individual will at t=1 deposit a premium of P₁. Thus, at t=1 the amount of money on the individual account makes up

D₁=(1+r₁)D₀*+P₁

Please note that according to the present invention r₁, may be smaller than zero, i.e. negative.

According to, for instance, a contract made between the administrator of the system according to the present invention and the individual, an amount of money equal

r₁D₀*

will be transferred from the individual account 2 to the corresponding redistribution account 3. The arrow labelled 5 in FIG. 1 indicates this transfer of money.

At the same time another transfer of money will take place from the redistribution account 3 to the individual account 2, which transfer of money amounts to

s₁D₀*

as indicated by the arrow labelled 6 in FIG. 1. In the case study connected to example 1a presented below s₁ is the long bond yield at time t=0 readjusted such that the size of s₁ fits the length of the considered time period, i.e. from t=0 to t=1. However, one could imagine a number of other possibilities, for example that s₁ could denote the expected return for the period considered. Since U₀*=0 we ignore money transfers from the redistribution account 3 from time t=0 to t=1 at this stage. We will consider such transfers below while considering the development from time t=1 to t=2.

After the above money transfers have taken place the balance of the individual account amounts to (indicated by *):

D₁*=(1+s₁)D₀*+P₁

and the balance of the corresponding redistribution account 3 amounts to

U₁*=(r₁−s₁)D₀*.

At t=2, a return of the order r₂ will have been produced on the individual account 2 and the individual will have deposited P₂ on his individual account 2 resulting in a money balance of

D₂=(1+r₂)D₁*+P₂

which may be written as

D₂=(1+r₂)(1+s₁)D₀*+(1+r₂)P₁+P₂

Again, a money transfer that amounts to

r₂D₁*

will take place from the individual account 2 to the corresponding redistribution account 3 as indicated by arrow 5. Also, a money transfer amounting to

s₂D₁*

will take place from the redistribution account 3 to the corresponding individual account 2 as indicated by arrow 6. The balance now presented on the individual account 2 amounts to

D₂^{m}=D₂−r₂D₁*+s₂D₁*=(1+s₂)D₁+P₂

which may be written as

D₂^{m}=(1+s₁)(1+s₂)P₀+(1+s₂)P₁+P₂

During the same period of time considered, the amount of money on the redistribution account 3 will also have produced a return of r₂ and the balance of the redistribution account 3 amounts to (before the money transfers have taken place):

U₂=(1+r₂)U₁*

and a fraction α (or all thereof) of U₂ is transferred from the redistribution account 3 to the individual account 2, i.e. a money transfer according to arrow 7 equal to

αU₂=α(1+r₂)U₁*

is transferred from the redistribution account 3 to the corresponding individual account 2. α is here a number between zero and one. As will be shown in the example 1c below, α can be a variable depending on past experience. In general α can depend on the past in a number of ways, reflecting different strategies. The balance of the individual account 2 thus amounts to

D₂*=D₂^{m}+αU₂=(1+s₂)D₁*+P₂+αU₂=(1+s₂)D₁*+P₂+α(1+r₂)U₁*

and after the transfers have taken place the balance on the redistribution account 3 thus amounts to:

U₂*=U₂−αU₂+r₂D₁*−s₂D₁*=(1−α)U₂+(r₂−s₂)D₁*=(1−α)(1+r₂)U₁*+(r₂−s₂)D₁*.

Continuing similar derivations for the balance equation for the next coming year results in that these money balance equations can be written in the following recursive manner (for t in {1. . . , n}):

D₀*=P₀

U₀*=0

Dₜ*=(1+sₜ)Dₜ₋₁*+Pₜ+α(1+r₁)Uₜ₋₁* (1)

Uₜ*=(1−α)(1+rₜ)Uₜ₋₁*+(rₜ−sₜ)Dₜ₋₁*

As indicated above in the recursive formulae, returns of our underlying assets will be r_{3.} . . . , rₙ in the following n−2 periods and, again, an amount α of the balance of the redistribution account 3 is transferred from the redistribution account 3 to the individual account 2 each period. Typically, such periods could either be weeks, months or years. In our simulated case study below the length of each period is one year.

At some point in time, the savings contract ends let us say at time n. Here in example 1a n is predefined and deterministic. This is important for our market value calculation below. It can, however, also be stochastic and instantiated by one or more event. This latter case is discussed in example 1e. At termination the redistribution account 3 (positive or negative) is transferred to the risk taker account 1. The case where the redistribution account 3 is negative means that the owner of the risk taker account 1 has to pay money to the redistribution account 3. In any event the redistribution account 3 will have zero value after the transfer and it can be deleted from the system. The entire individual account 2 is of course transferred to the customer at termination. In example 1a considered here, the redistribution account 3 is transferred to the risk account 1 at termination. However, it is possible to transfer some or all of the redistribution account 3 to the risk taker account 1 before termination. In example 1e and 1g with annuity type payment streams, the redistribution account 3 is partly transferred to the risk taker account at times where benefits are paid out. In example Id below there is an ongoing transfer from the redistribution account 3 to the risk taker account 1.

Below we include an example (cf. table A) of the development of the recursion formula (1). The length of the period from t to t+1 considered is imagined as one year. We consider developments over five such one-year periods. In the first example, we see that the returns on the underlying fund, r₁, . . . , r₅, are quite low compared to the deposit returns s₁, . . . , s₅. We see that the redistribution account 3, U*, becomes negative and that the individual account 2, D*, does not suffer very much from the bad returns.

TABLE A

| t | P | r | s | U* | D* | α |
|---|---|---|---|---|---|---|
| 0 | 100 | — | — | — | 100 | — |
| 1 | 100 | −0.15 | 0.051 | −20.10 | 205.10 | 0.2 |
| 2 | 100 | −0.15 | 0.053 | −55.30 | 312.55 | 0.2 |
| 3 | 100 | −0.15 | 0.055 | −101.68 | 420.34 | 0.2 |
| 4 | 100 | 0.02 | 0.050 | −95.58 | 520.62 | 0.2 |
| 5 | 100 | 0.05 | 0.048 | −79.25 | 625.53 | 0.2 |

In the second example (cf. table B), we see that the returns on the underlying fund are quite high compared to the deposit returns. We see that the redistribution account 3 becomes positive slowing down the upside of the individual account 2.

TABLE B

| t | P | r | s | U* | D* | α |
|---|---|---|---|---|---|---|
| 0 | 100 | — | — | — | 100 | — |
| 1 | 100 | 0.25 | 0.051 | 19.90 | 205.10 | 0.2 |
| 2 | 100 | 0.35 | 0.053 | 82.41 | 321.34 | 0.2 |
| 3 | 100 | 0.15 | 0.055 | 106.34 | 457.97 | 0.2 |
| 4 | 100 | 0.02 | 0.050 | 73.04 | 602.56 | 0.2 |
| 5 | 100 | 0.05 | 0.048 | 62.56 | 746.82 | 0.2 |

Example 1a above is of course only an example, minor changes in the way the money transfers are taking place according to the present invention can lead to minor differences. For example, it is always a question whether something is supposed to take place primo a time period or ultimo a time period. Another difference could be the order of the money transfers considered above. One could for example argue that the money transfers corresponding to the arrows 5 and 6 are done first such that the redistribution account 3 amounts to (using the time period from t=1 to t=2 illustrated above):

(1+r₂)U₁*+(r₂−s₂)D₁*.

Based on this redistribution account 3, the money transfer corresponding to arrow 7 from the redistribution account 3 to the individual account 2 should equal

α{(1+r₂)U₁*+(r₂−s₂)D₁*}

instead of

α(1+r₂)U₁*

such as we got in (1). This will lead to the general recursion formula

D₀*=P₀.

U₀*=0

Dₜ*=(1+sₜ)Dₜ₋₁+Pₜ+α{(1+rₜ)Uₜ₋₁*+(r₁−sₜ)Dₜ₋₁*}

Uₜ*=(1−α)(1+rₜUₜ₋₁*)+(1−α)(rₜ−sₜ)Dₜ₋₁*

There are many similar minor adjustments that can be considered to the recursion formulae (1). However, the recursion formula (1) fully indicates the overall perspective of example 1 a. In the other examples below we only give one recursion formula without indicating how minor differences can change the recursion formula slightly.

Market Values of the Product Given in Example 1a

The result of this section is that there is a good candidate for the market value of the product of example 1a. To calculate a market value of a savings product can be difficult in situations, where there is no real market for such products. However, in such cases it is sometimes possible to calculate the market value based on parameters known from the market. Besides being difficult such a calculation can often be carried out in a number of reasonable ways with different results. One special case, however, is Unit Linked policies, where the market value is immediately available. The product illustrated in example 1a does also have a good candidate for the market value. Let a policy at time t have individual account Dₜ* and redistribution account Uₜ*. Let us say there is

nₜ=n−t

transfers left from the redistribution account to the individual account 2. Remember that n and hence also nₜ are predefined and deterministic. The customer's share of the redistribution account can be defined as

$${C}_{i} = {\sum }_{i = 0}^{{n}_{i} - 1} {α ( 1 - α )}^{′} = 1 - {( 1 - α )}^{n ,} .$$

Where the formula indicates that at the time i the share of α is transferred from the redistribution account 3 to the individual account 2 of that share that is left of the original redistribution account 3 at time t, namely: (1−α)^{t}. Another way to understand this formula is to notice that the risk taker account 1 has the share (1−α)ⁿ^{ₜ} left after nₜ transfer of the original redistribution account 3. Therefore, the customer's share is 1−(1−α)ⁿ^{ₜ}. In the above argument for the customer's market value of Uₜ*, we have employed the definition that the market value of the individual account is 100% of the account. This is an important and nontrivial assumption. It implies that the future deposit returns, the sₜ's are such that a market value of 100% is fair. One suggestion could be to let the sₜ's equal the long bond yield. While this is a very good deposit return for the customer, see case study in Section 2, then it is possible to risk manage such a system, see Section 2.3. So, since the system can be risk managed, it can also be sold and therefore a market price of 100% seems reasonable even though the customer might feel that the product is worth more. The conclusion being, if the product is sold on the market at the price 100% (corresponding to that a customer is allowed to place money on the individual account), then this is perhaps the best suggestion for a market value.

The derivation that the customer's market value of Uₜ* equals CₜUₜ* now follows from the fact that an aggregated share Cₜ of the redistribution account at time t is over time gradually redistributed to the individual account 2, and that any money on redistribution account 3 is given a market return until transfer from redistribution account 3 to the individual account 2 takes place, and that the market value of any transferred money is 100% once they appear on the individual account 2.

The market value at time t for the customer is therefore the individual account 2 plus the customer's share of the redistribution account:

Dₜ+CₜUₜ*.

This is very simple compared to the complicated solutions to the market value question when considering the less transparent old average return type of products. The customer's share Cₜ is calculated below (cf. table C) for the situation where the transfer from the redistribution account to the individual account happens once a year and where the transfer ratio a equals 20%.

TABLE C

| Years left | 3 | 5 | 10 | 20 |
|---|---|---|---|---|
| C₁ | 49% | 67% | 89% | 99% |

Policy Changes at the Market Value in Example 1a

There are a number of typical policy changes that should be possible for any general saving principle. For example, surrender or changes of time of termination of the contract. However, once the market value of an insurance policy is defined, then a general strategy for policy changes can be defined. Namely, that any changes are done at an unchanged market value. This is a simple and fair principle while changing a contract.

An illustration of the Way the Product of Example 1a Works

In this section we consider the development of the market value from time t−1 to time t example 1a. Considering this development enables us to understand the nature of the product. The conclusion of this section is indeed a fairly simple one, namely that the return from time t−1 to time t measured on the increase in the market value can be understood as if one invested ones market value of the individual account 2,

$${D}_{i - 1}^{*} ,$$

and the redistribution account 3 Uₜ₋₁ (this market value is Dₜ₋₁+Cₜ₋₁Uₜ₋₁ according to our section on market values) in the following way:

Cₜ₋₁(Uₜ₋₁+Dₜ₋₁) is invested in the underlying fund giving the return rₜ and

(1−Cₜ₋₁)Dₜ₋₁* is invested giving the deposit return sₜ.

The final one period return of the market value (Dₜ₋₁*+Cₜ₋₁Uₜ₋₁*), the customer has at time t−1, is therefore in-between rₜ and sₜ. So, the return on the market value of the savings of the customer equals

αₜrₜ+(1−αₜ)Sₜ,

for some αhd t. In this section we derive the above conclusion and derive a comment on the exact αₜ.

One can illustrate the practical implication of the system described in example 1a in the following way: First note from (1) that the market value of the individual account 2 at time t−1, Dₜ₋₁*, gives rise to two terms at time t. One term belonging to the individual account 2, (1 +sₜ)Dₜ₋₁*, and one term belonging to the redistribution account 3, (rₜ−sₜ)Dₜ₋₁*. The market value of the individual account Dₜ₋₁* therefore becomes

(1+Sₜ)Dₜ₋₁*+(rₜ−sₜ)CₜDₜ₋₁*

at time t. This may also be written as

(1+(1−Cₜ)sₜ+Cₜrₜ)Dₜ₋₁*.

Therefore, the return on the individual account for the period from t−1 to t is

(1−Cₜ)sₜ+Cₜrₜ

corresponding to an investment where the share Cₜ is invested in the underlying fund whereas the share (1−Cₜ) is invested in a fund giving the return sₜ. From redistribution account (1) also follows that the market value of the redistribution account 3 at time t−1, Cₜ₋₁Uₜ₋₁*, gives rise to two terms at time t. One term belonging to the individual account 2, α(1+rₜ)Uₜ₋₁*, and one belonging to the redistribution account 3, (1−α)(1+rₜ)C₁Uₜ₋₁*. The market value at time t of the redistribution account Cₜ₋₁Uₜ₋₁ * therefore becomes

α(1+rₜ)Uₜ₋₁*+(1−α)(1+rₜ)CₜUₜ₋₁* (2)

at time t. Here some reordering of terms gives that the market value of redistribution account 3 has return rₜ equal to the return of the underlying investment fund, such that the market value at time t stemming from the redistribution account 3 at time t−1 becomes (1+rₜ)Cₜ₋₁Uₜ₋₁*. To check this it follows from (2) that it suffices to note that

(1+rₜ)Cₜ₋₁

equals

α(1+rₜ)+(1−α)(1+rₜ)Cₜ.

But to check this is equivalent to verifying the equation

α+(1−α)Cₜ=Cₜ₋₁.

But this latter equation is a simple consequence of the fact that

$${C}_{i} = {\sum }_{i = 0}^{{n}_{i} - 1} {α ( 1 - α )}^{′}$$

$$and$$

$${C}_{i - 1} = {\sum }_{i = 0}^{{n}_{i}} {α ( 1 - α )}^{′} .$$

Therefore the total market value

Dₜ₋₁*+Cₜ₋₁Uₜ₋₁

increases throughout the period from t−1 to t to:

(1+(1−Cₜ)sₜ+Cₜrₜ)Dₜ₋₁*+(1+rₜ)Cₜ₋₁Uₜ₋₁*. (3)

The total market value therefore have a return on investments corresponding to an investment where the share αₜ is invested in the underlying fund whereas the share (1−αₜ) is invested in a fund giving the return sₜ, where αₜ is given by the formula

$${a}_{i} = \frac{{C}_{i} {D}_{i - 1}^{*} + {C}_{i - 1} {U}_{i - 1}^{*}}{{D}_{i - 1}^{*} + {C}_{i - 1} {U}_{i - 1}^{*}} \\ or \\ 1 - {a}_{i} = \frac{( 1 - {C}_{i} ) {D}_{i - 1}^{*}}{{D}_{i - 1}^{*} + {C}_{i - 1} {U}_{i - 1}^{*}} \qquad ( 4 )$$

It follows from (4) that αₜ=Cₜ when Uₜ₋₁*=0. It is seen that αₜ is close to one while there is still long time left until termination and that αₜ is dramatically decreasing towards zero towards the termination of the contract. It is also seen that αₜ is smaller when Uₜ₋₁* is small (for example negative) than when Uₜ₋₁* is big. Thus, the system creates a safer risk profile for the customer in volatile periods with a low return and a less safe risk profile while returns are better. This is due to the fact that the customer's share of the redistribution account 3 in this interpretation of how example 1a works, is fully exposed to the market return rₜ. When the redistribution account 3 is positive, the exposure to the market risk is bigger than when the redistribution account 3 is negative.

It is seen that it is also here almost prohibitively difficult to implement the system of example 1a without the redistribution account 3 introduced by this invention.

Illustrative Example 1b—Another Way to Implement Formula (1) from Example 1a

While the above illustrative example 1a reflects one implementation of the system according to the present invention, the following example reflects a variant of that implementation. The system is considered at t=2 at which time the balance of the individual account 2 makes up

D₂=(1+r₂)D₁*+P₂

According to for instance a contract made between the administrator of the system and the individual, the amount on the individual account 2 is changed to

D₂′=(1+s₂)D₁*+P₂

wherein superscript s indicates that s₂ is given, instead of r₂, as the return of the period considered, in the present situation from t=1 to t=2.

The difference between the changed amount, D₂^{s}, and the original amount, D₂, on the individual account 2 is transferred to the redistribution account 3, i.e.

D₂−D₂^{s}=(1+r₂)D₁*+P₂−(1+s₂)D₁*−P₂=(r₂−s₂)D₁*.

is transferred from the individual account 2 to the redistribution account 3. Also in this situation the transfer can be negative, i.e. money is transferred from the redistribution account 3 to the individual account 2.

At t=1 the balance of the redistribution account 3 amounts to U₁*. and this balance has been invested in underlying assets. Thus, at t=2 the redistribution account 3 contains the amount of money U₂=(1+r₂)U₁*. A portion of the credit balance U₂ is transferred to the individual account 2. This portion is typically ruled by a contract made between the individual and the administrator of the system and may be a fixed percentage α or is determined by function as discussed in illustrative example 1a. Thus, according to the present example, a percentage a of U₂ is transferred from the redistribution account 3 to the individual account 2, i.e. the amount

αU₂=α(1+r₂)U₁*

is transferred to the individual account 2 (the above implies, in order for the transfer to be different from zero, that U₁*. is different from zero).

Summing up the actual amounts on the different accounts result in that theamount on the individual account 2 sums to

D₂*=(1+r₂)D₁*+α(1+r₂)U₁*−(r₂−s₂)D₁*+P₂

or

D₂*=(1+s₂)D₁*+P₂+α(1+r₂)U₁*

and the amount on the redistribution account 3 sums to

U₂*=(1+r₂)Uₜ−α(1+r₂)U₁*+(r₂−s₂)D₁*

or

U₂=(1−α)(1+r₂)U₁*+(r₂−s₂)D₁*

Also, this implementation may be written in the recursive manner identical to (1) given in example 1a above, i.e. (for t in {1, . . . , n}):

D₀=P₀ (5)

U₀=0

Dₜ*=(1+sₜ)Dₜ₋₁*+Pₜ+α(1+rₜ)Uₜ₋₁*

Uₜ*=(1−α)(1+rₜ)Uₜ₋₁*+(rₜ−sₜ)Dₜ₋₁*.

Illustrative Example 1c

In order to increase the flexibility of the present invention, money transfer from the redistribution account 3 to the individual account 2, α, could be determined by a function depending on characteristic variables for the invention as disclosed above. For example, α could be a variable taking into account a guaranteed return on the individual account.

For instance, α could be of such a character that if the redistribution account 3 becomes too negative then α becomes accordingly smaller so a guaranteed return g on the individual account 2 is maintained. The price of this guarantee could be that α also becomes smaller when the redistribution account 3 is very positive. In other words, α can be operational to design a guarantee g on an investment product according to the present invention that can be paid from the upside of the underlying investments.

This adjusted α can therefore both depend on g and t. We now define one system with such a α_{g,t}. We want the total increase of the individual account to be at least what the guarantee g demands. Thus, with the notation

Uₜ=(1+rₜ)Uₜ₋₁*,

we can use the original α when the return on Dₜ₋₁* is bigger than the guaranteed return

sₜDₜ₋₁*+α(1+rₜ)Uₜ₋₁*=sₜDₜ₋₁*+αUₜ≧gDₜ₋₁*.

Otherwise we have to adjust α. We assume that sₜ≧g. Hence (6) is of course true for Uₜ=0. When Uₜ<0 then (6) is true when

$$α \leq - ( {s}_{i} - g ) \frac{{D}_{i - 1}^{*}}{{U}_{i}} .$$

When Uₜ<0 we therefore define the adjusted α by

$${α}_{g , i} = min \{ {α}_{i} - ( {s}_{i} - g ) \frac{{D}_{i - 1}^{*}}{{U}_{i}} \}$$

We see that for Uₜ<0 we always have that

sₜDₜ₋₁*+α(1+rₜ)Uₜ₋₁*=sₜDₜ₋₁*+α_{g,t}U≧gDₜ₋₁*. (7)

The risk taker account has to take a risk due to this guarantee. We suggest taking a payment for this particular risk by a symmetrysing principle. We simply define α_{g,t} to equal

$${α}_{g , i} = min \{ α , ( {s}_{i} - g ) \frac{{D}_{i - 1}^{*}}{{U}_{i}} \}$$

when Uₜ>0. Hence the slow down of negative bonus due to the guarantee when Uₜ is negative is paid by an equivalent slow down of positive bonus when the Uₜ is positive. When Uₜ is positive, the α_{g,t} therefore simply equals the α_{g,t} we would have had if Uₜ instead of being positive had been negative with value −Uₜ. Our final definition of the adjusting α, α_{g,t}, is therefore that α_{g,t}=α when Uₜ=0 and

$${α}_{g , i} = min \{ α , ( {s}_{i} - g ) \frac{{D}_{i - 1}^{*}}{\vert {U}_{i} \vert} \}$$

otherwise. For this guaranteed average return product we get the following recursion formulae for t in {1, . . . , n}:

D₀=P₀,

U₀=0

Dₜ*=(1+sₜ)Dₜ₋₁*+Pₜ+α_{g,t}(1+rₜ)Uₜ₋₁*

Uₜ*=(1−α_{g,t})(1+rₜ)Uₜ₋₁*+(rₜ−sₜ)Dₜ₋₁*.

that equals (1) apart from the fact that α_{g,t} has replaced α.

Below we include two examples (cf. tables D and E) of the development of the recursion formula (8), with guarantee g=2%. We have used the same external variables as we used in the example following (1) such that comparison to that example is straightforward. We see that in the situation with bad returns the guaranteed principle results in a bigger individual account 2 and a more negative redistribution account 3 than we obtained in the nd of example 1a. We also see that α_{g,t} becomes smaller than 20% for the last 3 years.

TABLE D

| t | P | r | s | U* | D* | α_{g} |
|---|---|---|---|---|---|---|
| 0 | 100 | — | — | — | 100 | — |
| 1 | 100 | −0.15 | 0.051 | −20.10 | 205.10 | 0.20 |
| 2 | 100 | −0.15 | 0.053 | −55.30 | 312.55 | 0.20 |
| 3 | 100 | −0.15 | 0.055 | −102.31 | 420.98 | 0.19 |
| 4 | 100 | 0.02 | 0.050 | −101.96 | 527.00 | 0.14 |
| 5 | 100 | 0.05 | 0.048 | −89.40 | 635.69 | 0.15 |

In the situation with good returns the guaranteed principle results in a smaller individual account 2 and a bigger redistribution account 3 than what we obtained in the same case of good returns in the end of example 1a. This reflects the way that the guarantee is administrated over the redistribution account 3. Also here α_{g,t} becomes smaller than 20% for the last 3 years.

TABLE E

| t | P | r | s | U* | D* | α_{g} |
|---|---|---|---|---|---|---|
| 0 | 100 | — | — | — | 100 | — |
| 1 | 100 | 0.25 | 0.051 | 19.90 | 205.10 | 0.20 |
| 2 | 100 | 0.35 | 0.053 | 82.41 | 321.34 | 0.20 |
| 3 | 100 | 0.15 | 0.055 | 113.10 | 451.21 | 0.13 |
| 4 | 100 | 0.02 | 0.050 | 85.72 | 589.88 | 0.14 |
| 5 | 100 | 0.05 | 0.048 | 73.18 | 736.20 | 0.20 |

It is seen that it is also here almost prohibitively difficult to implement the system of example 1c without the redistribution account 3 introduced by this invention.

While the system is rather fair it does not live up to a financial criteria of eliminating the financial arbitrage for all possible ways of paying premium. We believe the system to be more or less without arbitrage options if we consider the premium to be determined at the start of the contract. Many contracts do determine the premium income independent of the events on the financial markets. It is for example common to pay a certain percentage of the premium income each month. However, it is possible to extend the above interest guarantee into more flexible premium payment patterns. Also here the redistribution account 3 can be helpful. If for example, a customer is allowed to (and decides) to stop paying premium at a time with a very negative redistribution account 3 this can be an advantage to the customer, since it becomes more likely that a bigger share of the negative redistribution account 3 eventually will be passed on to the risk taker account 1. One way to circumvent this could be to transfer a share of the negative redistribution account 3 to the individual account 2. This share should have a size that exactly matches the advantage of stopping to pay premium. Something similar could happen if a customer decides to pay in extra money at a time with a very positive redistribution account. Since this would give the customer the advantage that it becomes more likely that he gets a bigger share of the positive redistribution account 3, one could redistribute a financially fair share of the redistribution account 3 to the risk taker account 1 at such a time.

Illustrative Example 1d

Another way of increasing the flexibility of the present invention is to allow money transfer from the redistribution account 3 to the risk taker account 1 during the lifetime of the policy. Notice that in example 1a and 1b above money transfer from the redistribution account 3 to the risk taker account 1 was only allowed to take place at termination.

If we take our illustrative example 1a as our starting point, and we transfer an amount of money equal to β(1+rₜ)Uₜ₋₁* from the redistribution account 3 to the risk taker account 1 at each period in time, where we assume that α+β is between 0 and 1. The recursive formulae of the system get the following appearance:

D₀=P₀

U₀=0

Dₜ*=(1+sₜ)Dₜ₋₁+Pₜ+α(1+rₜ)Uₜ₋₁*

Uₜ*=(1−α−β)(1+rₜ)Uₜ₋₁*+(rₜ−sₜ)Dₜ₋₁*.

The effect of a running money transfer to the risk taker account 1 is to lower the risk of the individual account 2, while increasing the involvement of the risk taker account 1. If we consider the division into a hypothetical return resulting from having a part of the investment, αₜ, receiving the deposit return sₜ and another part of the investment, 1−αₜ, receiving the market return rₜ, in the same manner as in “An illustration of the way the product of example 1a works” following example 1a. Then we get the exact same type of calculation resulting in

$${a}_{i} = \frac{{C}_{i} {D}_{i - 1}^{*} + {C}_{i - 1} {U}_{i - 1}^{*}}{{D}_{i - 1}^{*} + {C}_{i - 1} {U}_{i - 1}^{*}}$$

$$or$$

$$1 - {a}_{i} = \frac{( 1 - {C}_{i} ) {D}_{i - 1}^{*}}{{D}_{i - 1}^{*} + {C}_{i - 1} {U}_{i - 1}^{*}}$$

The only difference is that the customer share Cₜ is changed into

$${C}_{i} = {\sum }_{i = 0}^{{n}_{i} - 1} {α ( 1 - α - β )}^{′} .$$

It is seen from this formula of Cₜ (that has a similar market value interpretation as the Cₜ of example 1a had) that the product of this example 1d has a smaller customer share in the underlying fund and a bigger involvement towards the deposit return sₜ than the product of example 1a had. Therefore, this product has a safer risk profile than the product of example 1a. It is also seen (like in example 1a) that αₜ is smaller when Uₜ* is small than when Uₜ* is big. Thus, as in example 1a, the system creates a safe risk profile in periods with low returns and a less safe risk profile while returns are better.

It is seen that it is also here almost prohibitively difficult to implement the system of example 1d without the redistribution account 3 introduced by this invention.

Illustrative Example 1e

Another way of increasing the flexibility of the present invention is to allow more flexible payment patterns than the simple lump sum considered in the examples 1a, 1b and 1c (where everything is paid at one particular time). So, in the beginning of the contract we have

D₀=P₀

U₀=0

Dₜ*=(1+sₜ)Dₜ₋₁*+Pₜ+α(1+rₜ)Uₜ₋₁*

Uₜ*=(1−α)(1+rₜ)Uₜ₋₁*+(rₜ−sₜ)Dₜ₋₁*.

However, at time t an amount corresponding to the share γ, of the money on the individual account 2 is paid out. We assume that γ, is predetermined and deterministic. This results in the following recursion formula while money is being paid out of the contract (where the premium is Pₜ=0):

Dₜ*=(1−γₜ){(1+sₜ)Dₜ₋₁+α(1+rₜ)Uₜ₋₁}

Uₜ*=(1−γ){(1−α)(1+rₜ)Uₜ₋₁+(rₜ−sₜ)Dₜ₋₁*}

for a sequence of numbers γₜ between 0 and 1.

In the example below the period is set to one year with an annuity where 10 payments are paid the last 10 years of the contract. We consider an extremely simple payment profile where one tenth of the individual account is paid out with 10 years left, one ninth is paid out with 9 years left and so forth. Therefore, in the last 10 years of the contract (where the premium Pₜ is 0) we have

$${γ}_{t} = \frac{1}{{n}_{i + 1}} = \frac{1}{( n - t + 1 )}$$

where nₜ denotes the number of periods before termination of the contract at time t and n denotes the total number of periods when the contract was started, see also example 1a.

If we consider the division into a hypothetical return, resulting from having a part of the investment, αₜ receiving the deposit return sₜ and another part of the investment, 1−αₜ, receiving the market return rₜ, in the same manner as in section “An illustration of the way the product of example 1a works” following example 1a. Employing the assumption that γₜ is predetermined and terministic, we get the exact same calculation resulting in

$${a}_{i} = \frac{{C}_{i} {D}_{i - 1}^{*} + {C}_{i - 1} {U}_{i - 1}^{*}}{{D}_{i - 1}^{*} + {C}_{i - 1} {U}_{i - 1}^{*}}$$

$$\begin{matrix}or \\ 1 - {a}_{t} = \frac{( 1 - {C}_{t} ) {D}_{t - 1}^{*}}{{D}_{t - 1}^{*} + {C}_{t - 1} {U}_{t - 1}^{*}}\end{matrix}$$

The only difference is that the customer share Cₜ (which also here has a market value interpretation as the customer share considered in example 1a and example 1d) is changed into

$${C}_{i} {\sum }_{i = 0}^{{n}_{i} - 1} {( α ( 1 - α ) )}^{′} {\prod }_{j = 0}^{i} {( 1 - {γ}_{i + j} )}^{j}$$

Therefore, the safety mechanism considered in example 1a and example 1d is also present here. It is seen that it is also here almost prohibitively difficult to implement the system of example 1e without the redistribution account 3 introduced by this invention.

Illustrative Example 1f

In this example the termination point n of example 1a is stochastic. Termination could for example be envisioned at death or disability, but a number of alternative possibilities of stochastic termination points are possible. Otherwise the development of the contract equals the development of example 1a.

D₀=P₀

U₀=0

Dₜ*=(1+sₜ)Dₜ₋₁*+Pₜ+α(1+rₜ)Uₜ₋₁*

Uₜ*=(1−α)(1+rₜ)Uₜ₋₁*+(rₜ−sₜ)Dₜ₋₁*.

Notice that the main points of “An illustration of the way example 1a works” following example 1a is still valid when the termination is stochastic. If such a system should be implemented without our invention, it would most likely amount to a retrospective revaluation of the return since the beginning of the contract at termination. Also this would be very hard to administrate. It is seen that it is also here almost prohibitively difficult to implement the system of example 1f without the redistribution account 3 introduced by this invention.

Illustrative Example 1g

Another way of increasing the flexibility of the present invention is to allow more flexible payment patterns than the simple lump sum considered in the examples 1a, 1b and 1c (where everything is paid at one particular time). In this example we consider a life annuity, where money are paid out as long as the policyholder is alive. A risk premium being paid to the policyholder in every period. This risk premium normally would equal an estimated mortality, μₜ, of the policyholder times the deposit account. At termination, at death, the individual account 2 is transferred to whatever took care of the risk premium being paid while the policyholder was alive. This could typically be the risk taker account 1, but it could also be some external insurance unit. So, while the life annuity is still not being paid out we have for all t until termination:

D₀=P₀

U₀=0

Dₜ*=(1+sₜ)Dₜ₋₁+Pₜ+α(1+rₜ)Uₜ₋₁*+μₜDₜ₋₁

Uₜ*=(1−α)(1+rₜ)Uₜ₋₁+(rₜ−sₜ)Dₜ₋₁.

The termination point n is stochastic and is determined by the death of the pensioner.

D₀=P₀

U₀=0

Dₜ*=(1+Kₜ){(1+sₜ)Dₜ₋₁+α(1+rₜ)Uₜ₋₁*}+μₜDₜ₋₁

Uₜ*=(1−kₜ)└(1−α)(1+rₜ)Uₜ₋₁*+(rₜ−sₜ)Dₜ₋₁*┘

where the amount kₜ is due to an annuity calculation determining the payment profile of the policyholder. Traditionally, such a calculation would calculate a constant annuity payment based on an assumed mortality and an assumed interest rate. Most likely these will be on the safe side resulting in a mortality and an interest rate that are lower than the expected values of these guaranties. However, many alternative payment opportunities exist leading to different types of calculations. A traditional kₜ could be calculated as

$${k}_{t} = {D}_{t - 1}^{*} / {\overline{a}}_{x - t}^{( r )} ,$$

where \overline{α}ₓ^{(r)} is the standard actuarial notation for a continuous annuity based on the interest rate r being paid out (to an individual of age x+t at time t) the rest of his life. While this is a continuous approximation to a discrete world, then one could also have done this approximation by other types of annuities, standard textbooks of actuarial science for more details.

It is seen that it is also here almost prohibitively difficult to implement the system of example 1d without the redistribution account 3 introduced by this invention.

Administration Costs

Any financial service has administration costs. In our product administration costs could for example be taken of the Dₜ, Pₜ or Uₜ^{t}. In traditional pension products it is quite common to take administration costs from the premium, like our Pₜ, while most Unit Linked policies seem to take administration costs as a fraction of some deposit accounts, like our Dₜ*. While the current invention, of course, has the potential of applying the well known principles while taking administration costs, then the invention lends itself to a number of new possibilities. If, for example, one determines only to take administrative costs from Uₜ* when Uₜ* is positive and let us say the deposit return has been set equal to the long bond yield. In this case the customer only pays administration costs in periods, where he at least gets the return corresponding to the long bond yield. Such a scheme has an excellent risk profile for the customer, he only pays administration costs, when things are going well, while the whole is administrated freely, when things are going less well.

2. A Case Study Connected to Example 1A

We consider four different underlying investment portfolios. These investment portfolios are constructed by taking different relative investment strategies, using four types of investment assets: Danish long term bonds, Danish stocks, European stocks and global stocks. The low risk group has a distribution of (80%, 10%, 10%, 0%) in these four assets, the middle risk group has a distribution of (50%, 15%, 15%, 20%), the high-risk group has distribution (30%, 15%, 15%, 40%) and the very high-risk group has distribution (10%, 5%, 5%, 80%). We assume these returns are lognormally distributed, where the logarithm of one plus the return (before tax) has mean 6%, 8%, 8% and 8.5% and standard deviation 6%, 18%, 18% and 20% for the four types of investments assets. Tax is following the Danish tax law where 15% of any return, positive as well as negative, is taxed. The four entering normal distributions are assumed to have correlation 0.5 with each other. This is a rather simple econometric model and it could be refined. For example, it is of course well known that the interest rate drops in years with good returns on bonds. However, it is a well-known fact that more complicated econometric models does not always improve prediction. Actually, quite the contrary is often the case, more simple models predict best into the future, whereas more complicated models are useful to fit the past. We are convinced that the fundamental conclusions that we arrive at with our simple econometric approach are correct, and we consider the clarity of our simple model to be more important than the improved prediction, we might be able to obtain with another econometric model. All presented results are based on a policy with premium 100 a year. We consider four different saving strategies. First the straightforward one, where everything is invested in a Unit Linked policy within one of the four risk groups. There is a common believe that while the risk is appropriate in the beginning of the investment period then safety is more appropriate towards the time of pension. We consider two such investment strategies where the underlying assets are manipulated according to the time horizon of the individual investor, namely one with 50% in stocks and 50% in bonds except in the last five years of the period, where stocks gradually are replaced by the more safe bonds. The second investment method has an initial investment mix of 80% in stocks and 20% in bonds. The investment is gradually reversed to a mix of 20% in stocks and 80% in bonds. Finally, we consider the new average return principle used on underlying assets invested according to the principles of the four considered risk groups. We present results with α=20%.

2.1. Method to Compare Long Term Performance of Investment System

Our approach towards comparison of different investment systems is the following: We would like the downside risk to be small, the medium return to be reasonable and when those two are assured, we also take a look at the upside possibility. We consider investment horizons 5, 10, 20 and 30 years and measure the downside risks by the 1% and the 5% quantiles, the medium return by the 50% quantile and the upside possibility on the 90% quantile. The fact that the low quantiles are relatively lower than the high quantile is high reflects the risk aversion of the customer. Instead of formulating the risk aversion in terms of a utility function, we use this more straightforward interpretation of these four quantiles.

2.2. The Pension Strategies Seen from the Customer

In the following we go through the specific properties of risk and return for example 1.a. In section 2.2.1 we look at the standard Unit Linked product described in the introduction. This is done to enable comparison in Section 2.2.2. We include the so-called strategic Unit linked product, where the investment strategy is changed into a more safe risk profile towards the time of pension. In section 2.2.3 the average return principle of example 1a is considered.

2.2.1 Return of a Standard Unit Link Policy

In the table below (table F) the considered quantiles are given for an investment in a standard Unit Linked product. It is seen that the low risk groups are safer than higher risk groups for all the considered horizons and that the median and in particular the upside is higher for the higher risk groups. This is straightforward and as one would expect. However, a lot of the financial folklore out there, argues that stocks are rather safe in the long run. Our simulations argue that the risk of investing in stocks endures at least 30 years and we do not think that our model overestimates the risk of stocks. Quite the contrary, the assumption of independent identical distributed returns might underestimate the risk of the long term investor, since recessions of long periods are unlikely to occur in such a model. We therefore clearly prefer the numbers calculated below to historical comparisons.

TABLE F

| | | Years | | | |
|---|---|---|---|---|---|
| UNIT LINKED | quantile | 5 | 10 | 20 | 30 |
| Low | 1% | 582 | 1137 | 2576 | 4715 |
| | 5% | 611 | 1220 | 2892 | 5464 |
| | 50% | 692 | 1472 | 3875 | 8019 |
| | 90% | 768 | 1723 | 4889 | 10893 |
| Moderate | 1% | 556 | 1076 | 2432 | 4471 |
| | 5% | 593 | 1187 | 2858 | 5517 |
| | 50% | 707 | 1546 | 4272 | 9506 |
| | 90% | 821 | 1924 | 5999 | 14738 |
| High | 1% | 530 | 1007 | 2250 | 4065 |
| | 5% | 575 | 1135 | 2732 | 5295 |
| | 50% | 716 | 1594 | 4558 | 10553 |
| | 90% | 868 | 2107 | 7046 | 18568 |
| Very high | 1% | 481 | 879 | 1838 | 3175 |
| | 5% | 537 | 1035 | 2391 | 4522 |
| | 50% | 725 | 1636 | 4797 | 11427 |
| | 90% | 943 | 2402 | 8828 | 25208 |

2.2.2 Return of Unit Link Strategies Compared to the Standard Unit Link Principle

We only consider Unit Linked strategies over the 30 years time horizon. The first strategy considered is a portfolio that smoothly moves from a portfolio with 20% in bonds towards a less risky portfolio of 80% in bonds. Compared to the standard Unit Linked principle, the 20%-80% principle is a bit less risky on the downside than medium risk Unit Linked. It is a bit more risky on the downside low risk Unit Linked and it is a bit better on the upside than low risk Unit Linked. It is a bit worse on the upside than the medium risk Unit Linked. It seems quite clear that this 20%-80% strategy does not give significantly better risk profile than the standard Unit Linked strategy of Section 2.2.1. The same type of conclusion holds regarding the second strategy of transferring the investment into bonds the last 5 years. It is interesting to anticipate the next section a bit and notice that both these strategic Unit linked strategies are worse at all four considered quantiles than the average return principle based on α=20% and the underlying fund of high risk. Our conclusion is that the strategic Unit Linked strategies considered in this section simply does not provide safety (cf. table G)

TABLE G

| UNIT LINKED | quantile | 30 years |
|---|---|---|
| From 20% to | 1% | 4693 |
| 80% in Bonds | 5% | 5620 |
| | 50% | 9135 |
| | 90% | 13684 |
| Last 5 years | 1% | 4582 |
| Got to Bonds | 5% | 5526 |
| | 50% | 9106 |
| | 90% | 13784 |

2.2.3 Returns Based on the Average Return Principles of Example 1A

While looking at the average return principle below over a 30 years horizon, we see that all four considered quantiles of the high risk average return are better than the quantiles of both the low risk and the moderate risk of Unit Linked. This could be reformulated as: the average return principle is capable of providing the safety of a low risk investment, but with the upside of a moderate risk profile. This is an astonishing good result and it shows the potential of the average return principle when compared to standard Unit Linked products. The particular chosen α=20% gives a very high safety for shorter horizons with an increasing upside due to stock exposure for longer horizons. In our opinion a sensible choice for most pension schemes. (cf. table H).

TABLE H

| Without guarantee | | Years | | | |
|---|---|---|---|---|---|
| AVERAGE RETURN | quantile | 5 | 10 | 20 | 30 |
| Low | 1% | 657 | 1299 | 2930 | 5279 |
| | 5% | 664 | 1339 | 3146 | 5879 |
| | 50% | 684 | 1447 | 3779 | 7839 |
| | 90% | 703 | 1556 | 4426 | 10007 |
| Moderate | 1% | 650 | 1277 | 2848 | 5138 |
| | 5% | 660 | 1322 | 3123 | 5925 |
| | 50% | 688 | 1478 | 4051 | 8921 |
| | 90% | 716 | 1644 | 5118 | 12710 |
| High | 1% | 642 | 1246 | 2717 | 4839 |
| | 5% | 655 | 1300 | 3045 | 5764 |
| | 50% | 690 | 1498 | 4237 | 9701 |
| | 90% | 728 | 1723 | 5762 | 15514 |
| Very high | 1% | 628 | 1183 | 2447 | 4100 |
| | 5% | 644 | 1257 | 2814 | 5167 |
| | 50% | 692 | 1515 | 4398 | 10391 |
| | 90% | 746 | 1852 | 6826 | 20147 |

2.3.4 Risk Management of the Product of Example 1A

The transparency of the product of example 1a makes risk management fairly straightforward. The major risk, the risk taker takes, is that the deposit return given is bigger than the actual investment return of the underlying fund. In the section “An illustration of the way the product of example 1a works”, we illustrated that the product could be understood as an investment where the individual account 2 is invested with a customer share Cₜ in the underlying fund and where (1−Cₜ) of the individual fund is given the deposit return sₜ. In this interpretation of the product of example 1a, the redistribution account 3 can be understood as fully invested in the underlying fund and the risk of the risk taker account 1 is therefore solely connected to the individual account 2. The involvement of the risk taker account 1 therefore corresponds to the return on the underlying fund (after tax) rₜ minus the deposit return sₜ times the aggregation of the shares of the individual account 2 that can be interpreted as being given the deposit return sₜ. In our simulated example we have after tax return rₜ equal to 0.85 times (tax is 15%) the return of one of the four considered underlying funds with respectively low, moderate, high or very high risk. sₜ is taken as 5.1% (corresponding to 0.85 times the long bond yield of 6%). Let

hₜ=rₜ−sₜ

equals the difference between the return of the underlying fund and the deposit return. Let us assume that the risk taker account covers n individuals with customer shares

Cₜ¹, . . . , Cₜⁿ

and individual accounts

Dₜ^{t}, . . . , Dₜⁿ

at time t. Let

$${\overline{C}}_{i} = \frac{{\sum }_{i = 1}^{n} {C}_{t}^{i} {D}_{t}^{i}}{{\sum }_{j = 1}^{n} {D}_{t}^{i}}$$

be the aggregated customer share of the individual account 2 of the n considered customers as a whole and let

$${\overline{D}}_{i} = {\sum }_{j = 1}^{n} {D}_{t}^{i}$$

be the aggregation of the n individual account 2. Under reasonable conservative portfolio assumption we obtain

\overline{C}ₜ=82% (9)

However, 1−\overline{C}ₜ could be between 10% and 30% for realistic portfolios. In a real life risk management the \overline{C}ₜ, will be defined from the composition of the portfolio. In the following we set \overline{C}ₜ=82%. We now make the assumption that

$${\overline{D}}_{t} ( 1 - {\overline{C}}_{t} ) = {\prod }_{j = 1}^{i} ( 1 + {h}_{i} ) {\overline{D}}_{0} ( 1 - {\overline{C}}_{0} ) .$$

This is an assumption we make out of convenience. It is, however, not unrealistic since it says something like that \overline{D}ₜ\overline{C}ₜ is decreasing after years with bad returns and it is increasing after years with good returns. In a real life risk management one will have to take reasonable expectations of the development of premiums and laps ratios (customers leaving the contract) into account. The assumption (10), however, allows a quick evaluation of the risk seen from the risk taker account 1. We believe the numbers arising from this quick evaluation give good rules of thumbs concerning the involvement of the risk taker account. Rules of thumbs are extremely important in the world of risk management, since it allows the risk taker to have an overall impression of the risk being taken. Such an overall impression should in practice be combined with more detailed calculations. However, also such detailed calculations, involving models of the development of premiums and laps ratios, are relatively straightforward to carry out in our case, since we have an exact formula for the risk taken. (Namely the formula given by “An illustration of the way the product of example la works”).

According to the assumption (10), the value increases seen from the risk taker account 1 at time t is

hₜ\overline{D}ₜ₋₁(1−\overline{C}ₜ₋₁).

Therefore, the gains or losses seen from the risk taker account 1 will correspond to the gain or losses realised from having invested \overline{D}₀(1−\overline{C}ₜ₋₁) at time 0 over t periods with the returns hₜ, . . . hₜ. We can therefore evaluate the risk of the risk taker account 1 by simulating hₜ, . . . , hₜ using simulated returns of the underlying fund. Below we have given a table (table I) of the total gains or losses over 1, 5, 10, 50, 100 years on the four considered quantiles, where we have used the assumptions (9) and (10). The gains or losses are given in the table below as the total gain or loss over the period divided by \overline{D}₀. We see that the reserve of 10% of the aggregated individual accounts is sufficient to have a certainty of 99% of not going broke in the next ten years for the low, the moderate and the high risk. Only the very high risk needs a reserve of 14% for a 99% certainty over 10 years. It is also seen that in the very long run, 50 years or 100 years, the high and very high risk are indeed safer than the lower risk (on most of the downside quantiles). This indicate that the expected surplus of the bigger stock investment of these two investment strategies add up over time and eliminates the risk. So, with a reserve of about 10% of the aggregated individual accounts it seems reasonable safe to use the product of example 1a.

Table of company gains and losses with the four quantiles with a stabilised portfolio according to the assumption (10):

TABLE I
S = 5.1 after taxes α = 20%

| | | Years | | | | |
|---|---|---|---|---|---|---|
| | quantile | 1 | 5 | 10 | 50 | 100 |
| Low | 1% | −0.023 | −0.051 | −0.070 | −0.124 | −0.137 |
| | 5% | −0.017 | −0.035 | −0.045 | −0.067 | −0.054 |
| | 50% | 0.001 | 0.007 | 0.014 | 0.070 | 0.141 |
| | 90% | 0.017 | 0.041 | 0.062 | 0.174 | 0.290 |
| Moderate | 1% | −0.031 | −0.066 | −0.082 | −0.105 | −0.050 |
| | 5% | −0.022 | −0.042 | −0.050 | −0.026 | 0.060 |
| | 50% | 0.003 | 0.016 | 0.033 | 0.165 | 0.331 |
| | 90% | 0.025 | 0.065 | 0.101 | 0.314 | 0.543 |
| High | 1% | −0.038 | −0.081 | −0.102 | −0.110 | −0.016 |
| | 5% | −0.027 | −0.052 | −0.060 | −0.009 | 0.124 |
| | 50% | 0.003 | 0.022 | 0.046 | 0.232 | 0.466 |
| | 90% | 0.032 | 0.085 | 0.135 | 0.427 | 0.740 |
| Very high | 1% | −0.052 | −0.111 | −0.141 | −0.159 | −0.040 |
| | 5% | −0.037 | −0.074 | −0.086 | −0.021 | 0.156 |
| | 50% | 0.004 | 0.030 | 0.060 | 0.314 | 0.628 |
| | 90% | 0.045 | 0.118 | 0.187 | 0.586 | 1.013 |

3: A Case Study Connected to Example 1B

Below we have simulated our experience with the average return product of example 1b with guarantee g. We saw in Section 2.3.1 and Section 2.3.3 that the average return product compares better with Unit Linked products with underlying funds of lower risk than with Unit Linked products with underlying funds of similar risk. Something similar is true here, since the average return product without a guarantee best compares with the average return product with an underlying fund of lower risk. In the table below (table J) we compare the average return product without guarantee. We also compare an underlying fund of moderate risk with the average return product with a guarantee with an underlying fund of high risk. We see that while the risk profile of these two types of products is rather similar, the product without guarantee has a higher upside, but a slightly lower medium value return. The downside is almost the same for the two systems.

TABLE J

| Average return products | quantile | 30 years |
|---|---|---|
| Without guarantee, moderate risk | 1% | 5138 |
| | 5% | 5925 |
| | 50% | 8921 |
| | 90% | 12710 |
| With guarantee g = 2%, high risk | 1% | 5165 |
| | 5% | 5933 |
| | 50% | 9146 |
| | 90% | 11716 |

A closer inspection of the performance of the average return product of example 1b with guarantee 2% (cf. table K) shows that this product performs quite well for an underlying fund with low risk or moderate risk. The latter one is better than the average return product without guarantee and a low risk underlying fund on all four considered quantiles. On the other hand, the average return product of example 1b with guarantee is rather bad when the underlying fund is of very high risk. Here an average return product without guarantee, but with underlying fund of moderate risk or high risk, seems superior.

TABLE K

| With 2% guarantee | | Years | | | |
|---|---|---|---|---|---|
| AVERAGE RETURN | quantile | 5 | 10 | 20 | 30 |
| Low | 1% | 657 | 1303 | 2957 | 5364 |
| | 5% | 664 | 1340 | 3161 | 5909 |
| | 50% | 684 | 1447 | 3775 | 7817 |
| | 90% | 703 | 1551 | 4361 | 9786 |
| Moderate | 1% | 651 | 1289 | 2915 | 5326 |
| | 5% | 660 | 1327 | 3156 | 6006 |
| | 50% | 688 | 1475 | 4006 | 8701 |
| | 90% | 713 | 1600 | 4708 | 11150 |
| High | 1% | 646 | 1272 | 2865 | 5165 |
| | 5% | 656 | 1314 | 3110 | 5933 |
| | 50% | 690 | 1490 | 4109 | 9146 |
| | 90% | 719 | 1623 | 4857 | 11716 |
| Very high | 1% | 642 | 1250 | 2760 | 4875 |
| | 5% | 650 | 1292 | 2992 | 5617 |
| | 50% | 691 | 1494 | 4128 | 9219 |
| | 90% | 724 | 1639 | 4941 | 12050 |

In the following preferred embodiments of computer implementations according to the present invention is addressed and in particular a computer system comprising processors, data storage, e.g. database and routines adapted to handling the necessary data and the manipulation thereof. The computer system process data stored and stores data in the databases based on an actual pension scheme selected. Please see FIG. 2 for an overview of programme modules and data storage included in the description.

Basic Principles

As indicated in the previous sections the invention makes use of three accounts that are administered by routines in the computer system. In general, the present invention administers debit and credit on the individual account, the redistribution account and the risk taker account and the administration of the three accounts is basically based upon the following.

In general, administration of the different accounts are governed by events which may or may not trigger a transaction between some or all of the accounts or may or may not trigger making up of one or more account. According to the invention, two different type of events are considered namely regular event and key business event. Regular events occur regularly at predefined instants and in particular at instants labelled t−2, t−1, t, t+1, t+2 etc. which indicates that the events occur after identical or substantial identical time periods A time period, e.g. the time from t−1 to t, is typically one month, a predefined number of days, a year or the like, and the time period is typically reflected in, such as inputted as a parameter to, the computer system according to the present invention. Key business event are used for handling events which occur at a non-predefined time, tₑ. Typically, such key events occur within two regular events and relate for instance to a qualified pension event such as death.

Even though FIG. 3 indicates that only one event at a time can occur, several events can occur at the same point in time and a key business event can occur at the same time as a regular event. Of course, the event is said to occur at a particular time when it occurs within a given time window. For instance, if the time window is set to 24 hours, then an event occurring at for instance three o'clock on Sep. 25, 2001 is defined to occur at Sep. 25, 2001.

The debit and credit posting are for the key business event processed at the time the event occur and at end of period, as a part of the calculations of the regular events. The regular events are only processed end of period for making up the accounts for the coming period.

Accounts

Besides the three basic accounts, that is the individual account, the redistribution account and the risk taker account, the present invention may preferably include two other accounts, namely the individual transaction account and the investment fund account.

Each account of the system according to the present invention is embodied as databases which preferably stores debit and credit posts as records. In order to facilitate transactions, the computer system comprises a bookkeeping functionality, which keeps track of money transfers to—and from—the accounts by changing the content of the stored records and/or generating new records in response to the transfers effectuated. The databases will always contain information making it possible to make up the account and process money transfers.

To facilitate an eventual roll back of the accounts due to e.g. errors, every record refers, by an identification, to that particular event that has created the record.

Processing a Single Investor Contra Processing a Population of Investors

The described computer system is designed to manage the investments from not only one single investor but several investors. Elements in the design hereof comprises e.g. common information which will be shared among all investors e.g. product information and common event information. Information related to the individual investor comprises for example the agreement between the investor and the administrator, the individual accounts etc.

The description below focuses mainly on the processing of an individual investor although the computers system is designed to manage a population of investors.

Data Storage

In order to increase the flexibility the data, which are stored and/or used by the computer system, are grouped into the following groups:

A Product information

B Event Catalogue

C Investor's agreement

D Individual account

E Redistribution account

F Risk taker account

G Individual transaction account

H Investment fund

I Investment performance information

J Event processing information

K Individual event information

L Common event information

By grouping data which are linked by functionality and/or by dependency a system, which is easy well arranged and thereby easy adaptable to other needs or demands, is obtained. As will be shown below, the functionality of the computer system is provided by routines accessing the information groups whereby, for instance, a change made to the pension product may very advantageously be implemented into the system by modifying the content of the product information group. This feature will be elaborated further below after the content of each group has been presented.

A. Product Information

In general, the present invention is designed to be able to handle different pension products, as can be seen in the previous sections, and in particular examples 1a to 1g, in which different products are presented. In order to facilitate this flexibility, information needed in order to execute different products is stored in the product information database. This information is typically the products characteristics such as the percentage of the redistribution account to be transferred to the individual account, number of benefits to be paid to the investor, standard contract, parameters for the costs calculation etc. All these kind of product characteristics are preferably stored in the Product Information data storage.

B. Event Catalogue

The event catalogue is the key part of the implementation model. The event catalogue comprises information on how to calculate the debit/credit post to the various accounts when an event occurs. The information is organised in such a way that several sets of information, each covering how calculations are carried out for one specific product, are stored.

For every event the event catalogue comprises following information:

Identification of the individual event e.g. receipt of premium, payment of benefit and termination of contract.

The type of the event, which is a “regular event”, “key business event” or a “termination event”.

Information on which amount to debit or credit the various accounts, when the event occurs. The information covers for instance formulas for calculations to be made. The information is divided into amount to be posted when the event occur at the time tₑ and at the end of period—time t—please refer to the above description on the basic principles. The accounts are the Individual Account. The Redistribution Account, The Risk Taker Account, the Individual Transaction Account and the Investment Fund Account.

The sequence in which the event is processed at the time tₑ and at the time t. This sequence is used when several events occurs at the same time. For example can a premium receipt event be given the sequence number “1” and a termination of contract event be given a sequence number “2”. This means that the transactions to the accounts from the premium receipt event will be calculated before the termination account event, when both events occur at the same time.

Basis for calculations, e.g. the balance of the accounts, the interest rate etc.

The logical structure of the Event Catalogue is information typically covered in the Event Catalogue is shown in Table 1. Addition of extra columns for other investment funds will enable the event catalogue to support utilisation of several investing funds e.g. a certain fund for the Individual Account and another fund for the Redistribution account.

TABLE 1
The table shows the logical frame of the event catalogue

| | | Account | | | | | | | | | | | | |
|---|---|---|---|---|---|---|---|---|---|---|---|---|---|---|
| | | Individual | | Redistribution | | Risk Taker | | Individual | | Investment | | | Sequence | |
| | | Account | | Account | | Account | | Transaction A | | Fund Account | | Sequence | end of | |
| | | | End of | | End of | | End of | | End of | | End of | real time | period | Basis for |
| Event | Type | Real | period | Real | period | Real | period | Real | period | Real | period | processing | processing | calculations |

C Investor Agreement Information

The objective of this data storage is to make the implementation model able to process the investors individually.

The data storage for investor agreement information comprises information on the individual investor's agreements with the administrator. This covers e.g. the product agreed with the administrator—see above on product definition—, schedule for premiums, the number of benefits to pay etc.

D. Individual Account, E. Redistribution Account and the F. Risk Taker Account

These three accounts are the basic accounts in the invention. The accounts are described in the previous sections. The accounts comprises debit and credit transactions made at a certain time. Balances of the accounts are calculated by summing the transactions.

G. Individual Transaction Account

The objective of the Individual Transaction Account is to record all transactions made between the investor and the administrator. These transactions comprise typically the premiums that the administrator receives from the investor and the benefits the administrator pays to the investor. The balance of the account is calculated by summing the transactions.

H. Investment Fund Account

The objective of the Investment Fund Account is to keep record of all investments made by the administrator. The Investment Fund Account comprises information on the individual investment typically identification, financial instrument (e.g. shares, bonds, cash and property), trading information, market value, dividend etc.

The description focusing on using one single fund for the various investments. But the system could easily be expanded to use several investing funds e.g. a certain fund for the Individual Account and another fund for the Redistribution Account—or individual investing funds linked to the individual investor.

I. Investment Performance Information

The objective of the Investment Performance Information is to store information on the rate of return on the investments made, and other types of returns e.g. an expected rate of return, the long bond yield, other interest rates etc. All this information is used for the calculation of how much to add to the various accounts after a certain period of time e.g. after a month. The rates recorded are all related to a certain period of time e.g. by defining the start date end the end data for the rate.

The programme module for investing funds updates the data storage, which calculates the various rates.

J. Event Processing Information

The objective of the Event Processing Information is to keep track of the time period that has been processed. It is very important that the events are processed simultaneously by the time they occur. For example it is “illegal” to pay benefits or receive premiums after the contract has been terminated. It is not allowed to have unprocessed “holes” in the processed periods. This is the main reason for keeping track of the processed period. An example: It is not allowed to have one processed period from the 4^{th} of January to the 9^{th} of January and then the next processed period from the 23^{rd} of February to the 28^{th} of March.

K. Individual Event Information

The objective of the data storage for individual event information is keep track of all the events that are related to the individual investor. The information stored in the data storage is:

Event-id e.g. the “premium receipt event”, “benefits paid event” or “contract termination event”. All these events are typically key business events occurring at time T=tₑ.

The time when the event occurs e.g. the date

Checkmark/timestamp on when the event eventually has been processed. This is due for both the real time processing at the time T=tₑ and the end of period processing at the time T=t. Detailed explanation on the processing of the events is included in an extensive examples at the end of this section.

K. Common Event Information

The common event information comprises a list of events that are general and common to all investors. These events are typically regular events, for instance the periodically making up of the accounts. The data storage comprises the same type of data as the data storage for individual event information.

Programme Modules

The computer system according to the present invention comprises, typically, the following programme modules:

1. Maintaining investor's agreement

2. Managing premiums and benefits

3. Event processing

4. Handling costs

5. Investing funds

6. Maintaining basic information

7. Reporting

To support the understanding of the implementation model, flow diagrams are included. For enabling a better understanding of these flow diagrams two examples of the terminology used in the diagrams are included below.

Explanation 1. Flow Writing Information to a Data Storage

FIG. 4 shows a programme module writing information to a data storage—please note the arrow pointing at the data storage. The programme module uses “external” information to execute the process—please note the arrow pointing at the programme module.

Explanation 2. Flow Reading Information from a Data Storage

FIG. 5 shows a programme module reading information from a data storage—please note the arrow pointing from the data storage. The programme module dispatches the information to “external parties”—please note the arrow pointing away from the programme module.

As will be shown later on, the event catalogue controls these programme modules and these programme modules typically poses the functionality described in the following.

1. Maintaining Investor's Agreement

The objective of this module is to record and update the information related to the agreement with the individual investor. As indicated on FIG. 6 the module receives or extracts upon execution investor information externally and from the Product Information data storage. The investor information comprises special features of the pension product agreed upon between the administrator of the pension scheme and the individual investor. Based on this agreement product information relevant for the agreement is extracted from the product information database and an investor profile reflecting this agreement is generated and stored in the data storage for Investor Agreement Information. Furthermore the data storage for Individual Event Information is updated when key business events concerning the individual investor occur.

The information is generated and stored when the investor establish, changes or terminates the agreement related to the investment. The information generated and stored comprises the individual event information and investor information e.g. product-id, schedule and amount for premiums and benefits, termination of the agreement etc.

2. Managing Premiums and Benefits

The objective of this module is to manage the collection and receipt of premiums and the payments of benefits.

The module comprises the following three steps:

1. Collection of Premiums

This programme step has functionality embodied to ensure collection of the premiums, according to the agreement settled with the individual investor. As indicated in FIG. 7 the program module receives or extracts upon execution investor information to execute and manage the collection process.

2. Receipt of Premiums

This module step has functionality to manage the receipt of the premium paid by the investor. As indicated in FIG. 8, the module step receives the premium and transfers the amount to the individual transaction account. At the same time the module ensures that information on the receipt of the premium is recorded in the data storage for individual event information—This means that the module records that a premium receipt event has occurred.

3. Payment of Benefits

The objective of this program module step is to manage the payment of benefits. The step comprises two steps—3a. and 3b.

Step 3a. The objective of this step is to record a “benefit paid event” in the data storage for individual event information. As indicated in FIG. 9 the step receives information on the benefit to pay, typically the date of payment, and the module records the information in the data storage for individual event information. This step is a prerequisite for paying the benefit at all.

After the event has been recorded, the programme module for event processing is able to calculate all the transactions related to the payment of the benefit.

Step 3b. The objective of this step is to carry out the payment. As indicated in FIG. 10 the module receives information or extract upon execution information on the benefits from the investor transaction account. When disbursing the benefit the module will debit the investor transaction account the paid amount.

An example: If there is a benefit balance on the investor transaction account on 1.000, this amount can be paid to the investor. When the benefit is paid, a 1.000 is debited the account and the balance will be 0.

3. Event Processing

The event-processing module is the central engine for the entire implementation model. The objective of the module is to ensure that all events are processed and the accounts are updated correctly. Based on the rules defined in the event catalogue and the actual events that have occurred, this programme module controls the debit and credit posting the all accounts, especially the Individual Account, the Redistribution Account and the Risk Taker Account.

The programme module runs through all events recorded in the data storage for individual event and common event information, which have occurred in a specified period of time, identified by the time from T_{begin} to T_{end}. For every event the module looks up the event catalogue to see how to calculate the amounts to be debited and credited the various accounts.

The events are processed in succession by the time they occur. If more than one event occurs at the same time (in the same time window e.g. hour, day week, month etc., depending on the actual set-up of the system), identified by the time T, the events are processed simultaneously by their related sequence number. The sequence number is specified in the event catalogue.

The event-processing module comprises the following programme steps:

Step 1. Read T_{begin} and T_{end}

Step 2. Have any unprocessed events occurred at the time T?

Step 3. Process event with lowest sequence number

Step 3.1 Determine basis for calculations

Step 3.2 Calculate amounts

Step 3.3 Debit/credit amounts

Step 3.4 Checkmark event in data storage

Step 4. Is T=T_{end}

Step 5. Update event processing information

In FIG. 11, 12 and 13 the mechanism of the event-processing module is illustrated.

Step 1. Read T_{begin} and T_{end}

The objective of this first step of the event processing is to determine the time period to process.

As indicated in FIG. 14 the step read information concerning the time period from the data storage for event processing information. T_{begin} and T_{end} identify the time period.

Remember, as explained above, that the time T is a time window and could be a specific hour, date, week etc. The choice will be dependent on the actual requirements. The described implementation model is not limited to any of these and gives the freedom to decide whether to use hours, days, weeks etc. But—for explanation purposes—we often will use days in the descriptions below.

To enable the programme module to start at the beginning of the time period, the internal time (day) for processing events, T, is set to first day (“time window”) of the period T_{begin}.

Step 2 Have any Unprocessed Events Occurred at the Time T?

The objective of this step is to find all the events that have occurred at the time for processing T (in the time window).

As indicated in FIG. 15 the step reads information from the data storage for individual and for common events. As the data storage comprises data on the events especially the date and checkmark on whether they have processed or not, it is quite easy to find all the events that have occurred on the specific day and not already have been processed. As described earlier on in this section, events are valid for processing at the date they occur and at the end of period (at the regular times t−1, t, t+1, t+2 etc). To support this there are two checkmarks in the data storage for event information—a checkmark for the real time processing and a checkmark for end of period processing. If the time T is end of period—time t—, the module checks all events occurring from t−1 to t for checkmarks concerning the end of period processing, because the events are supposed to be processed at the time or day the occur and end of period.

If the step finds unprocessed events at the time T, the module proceeds to step 3. Otherwise the module proceeds to step 4.

Step 3. Process Event with Lowest Sequence Number

The objective of this step is to process one of the events found at step 2, and that particularly event with the lowest sequence number.

As indicated in FIG. 16 the step reads information from the event catalogue, to determine the sequence number—please refer to the description on the event catalogue. Every type of event has a sequence number defined in the event catalogue. If two events occur with the same sequence number, any of those events can be processed.

The processing of the individual event goes through four steps, which are described below.

Step 3.1 Determine Basis for the Calculations

The objective of this step is to determine the basis for the calculations to be made. Such basis could e.g. be the opening balance of the various accounts, the rate of return on the investments etc.

As illustrated in FIG. 17, the step read information from various data storage.

First of all, the step reads information from the event catalogue. In the event catalogue the variables, that forms the basis for the calculations, are defined for each event—please refer to Table 1. An example of a variable is the rate of return for the present period of time.

Secondly, the step looks up other data storage to determine the value of the variable. For example the value on the rate of return is found in the data storage for investment performance.

Step 3.2 Calculate Amounts

The objective of this step is to determine the debit/credit amount to be posted the accounts. As indicated in FIG. 18, the step reads formulas from the event catalogue and uses these formulas to calculate the amounts to be debited or credited the accounts. The step takes as input information, which has been calculated in the previous step, and the formulas specified in the event catalogue. Based thereon, the step provides the amount to be credited or debited the various accounts

Step 3.3 Post Debit/Credit to Accounts

The purpose of the step is to post the debit and credit the calculated amounts to the accounts. As illustrated in FIG. 19 the step gets the amounts (from step 3.2) and writes them to the accounts.

To enable an eventual roll back of the accounts due to e.g. errors, every record that is written to the account is stamped with the id of the event, which has created the record.

Step 3.4 Checkmark Processed Event

The objective of this step is to checkmark the event that has been processed. As illustrated in FIG. 20, the step writes a checkmark to that particular event, that has been processed, in the data storage for either the individual event information or the common event information. The step writes either a checkmark on real time processing or a checkmark for end of period processing depending on the specific case—please refer to description on the data storage for individual event information above.

The purpose of writing a checkmark is to keep track on the events that have been processed—included track on real time processing at the time T=tₑ and the end of period processing at the time T=t.

After the checkmark has been made in the data storage, the programme module returns to step 2.

Step 4. Is the Time T=T_{end}?

The objective of this module (illustrated in FIG. 21) is to find out whether the module has reach the end of the time period to process, T_{end}.

If the processing time T=T_{end} then the module proceeds to step 5.

Else the module returns to step 2. But before returning to step 2., the processing time T is set to the next time window T+dT, e.g. to the next day in the period—as indicated in FIG. 12.

Step 5. Update Event Processing Information

The objective of this step is to ensure that information concerning the processed time period is updated. As illustrated in FIG. 22 the step writes information to data storage for event processing information, in particular the start date T_{begin} and the end date T_{end}. Then the implementation model knows that the specific time period has been processed.

After the updating of the event processing information has been carried out, the programme module terminates.

4 Handling Costs

The objective of this module (illustrated in FIG. 23) is to calculate, i.e. determine and settle the costs to be paid by the individual investor. The costs are related to the administration of the investment service.

Due to the large flexibility of the present invention, the costs of managing the investment service can be determined in different ways and depends in general, as disclosed in the previous sections on one or more of the following issues: a decision of the administrator of the pension scheme; the agreement made between the administrator of the pension scheme and the individual, the trend in the economy or the actual status in the economy. Thus, based on the actual implementation of the cost calculation, various information from the data stored serves a basis for calculations of costs. Of course, the actual implementation of the cost calculation must be reflected in the content of the various databases of the system to assure the needed information is available.

Thus, calculation of costs normally comprises performing at least the following steps:

1. Calculate the Costs Related to the Individual Investor

As the cost calculation is based on the specific pension scheme for a specific individual the calculation will access parameters related to the pension scheme in question recorded in the data storage for product information. Typical parameters accessed are the rate to be paid of the return of the individual investment or of the balance of the redistribution account, a rate to be paid of the payments, fixed costs for termination of the investment and the like.

2. Settle the Costs

Once the costs has been determined based on the information provided by step 1 the costs are debited to one or more of the accounts in the implementation system. Of course, the information provided as a consequence of step 1 also cover from which account or account the costs should be debited or alternatively whether the costs should be covered in another manner for instance by a payment from the individual.

Investing Funds

The objective of the investing funds module is to administer the investments made and to calculate the return on the investment. For that reason the investment module is a very important for the supporting of the implementation.

The programme module comprises three major steps, which are described below:

Step 1. Recording Information on the Investments

The objective of this program module is to record and maintain basics information on the investments made.

As indicated in FIG. 24 the investment information is recorded and maintained in the investment information data storage. The information comprises typically the identification of the individual asset, trading information such as price paid or selling price and dividend gained on the investment.

An important part of the investment information is the market value of the individual asset. The market value of the assets is standardised gathered from external sources and recorded in the investment information data storage as indicated in FIG. 24.

Step 2. Calculation of Return on Investments

The objective of this step is to calculate the return on the investments. The module uses standardised investment methodologies to calculate the return of the investments. Normally the return is calculated from the trading information, the dividend received and the market value of the investment. The return is calculated for a certain period of time e.g. pr. day, month and year.

As indicated in FIG. 24 the module uses the information in the investment information data storage to execute the calculations and the rates are recorded in the data storage for investment performance information.

An example on calculation of rate of return: The individual investor has made an investment worth (market value) 100. If the market value of the investment rises to 110 after a certain period of time, the return on the investment is 10% in that specific period of time.

Step 3. Recording Other Rates

The objective of this module is to record other rates of returns used in the system. Such a rate is e.g. the long bond yield, which can be used for making up the individual account. The precise definition of the various rates is not important concerning the implementation model.

Many rates can standardised be provided from external sources. Calculations on rates will be made outside this module e.g. manually. As indicated in FIG. 24 the information is recorded and maintained in the data storage for investment performance information.

6. Maintaining Basic Information

The objective of this module is to record and update the basic information in the data storage e.g. product information, common event information etc. As indicated in FIG. 25 the module receives basic information externally and updates various data storage. Following data storage are recorded and updated:

Product Information including the product characteristics and costs parameters

Event catalogue with the event definition including formulas and basis for the calculations

Common event information including when to process the regular events

Event processing information including the planned time period to process.

7 Reporting

The objective of the module for reporting is to create reports for at least the administrator of the investment service, the risk taker and the investor.

As indicated in FIG. 26 the programme module potentially uses the information from all the data storage for the preparation of the reports.

Illustrative Example 2—Event Processing

In the following an illustrative example of how the computer system, according to the present invention works upon execution, is put forward. The focus will be pointed towards application of the event catalogue.

As shown in Table 12 the product defined in the event catalogue comprises five different events: Receipt of premiums, payment of benefits, update of accounts, transferral of the redistribution account to the individual account and termination of the contract.

TABLE 2
Event catalogue for the illustrative example 1.

| | | Account | | | | | | | | | |
|---|---|---|---|---|---|---|---|---|---|---|---|
| | | | | | | | | | | Investment | |
| | | | | | | Risk Taker | | Individual | | Fund | |
| | | Individual Account | | | | Account | | Transaction A. | | Account | |
| | | | End of | Redistribution Account | | | End of | | End of | | End of |
| Event | Type | Real | period | Real | End of period | Real | period | Real | period | Real | period |
| Premium | Key | +Pₜ″ | +Pₜ″ * sₑ₋ₜ | | +Pₜ″ * (rₑ₋ₜ − sₑ₋ₜ) | | | −Pₜ″ | | +Pₜ″ | |
| | business | | | | | | | | | | |
| | event | | | | | | | | | | |
| Benefits | Key | −Bₜ″ = | −Bₜ″ * sₑ₋ₜ | \ddot{\dot{B}}ₜ″ = | +Bₜ″ * (rₑ₋ₜ − sₑ₋ₜ) | \ddot{\dot{B}}ₜ″ | | −Bₜ″ | | +Bₜ″ | |
| | business | −(1/10) * D*ₜ₋₁ | | −(1/10) * | \ddot{\dot{B}}ₜ″ * rₑ₋ₜ | | | | | | |
| | event | | | U*ₜ₋₁ | | | | | | | |
| Update of | Regular, | | +D*ₜ₋₁ * sₜ | | +D*ₜ₋₁ * (rₜ − sₜ) | | | | | | |
| return on | event | | | | +U*ₜ₋₁ * rₜ | | | | | | |
| investment | | | | | | | | | | | |
| Transfer | Regular | | +α * Uₜ | | −α * Uₜ | | | | | | |
| of α from | event | | | | | | | | | | |
| RA to IA | | | | | | | | | | | |
| Termina- | Termina- | −D_{T} | | −U_{T} | | +U_{T} | | +D_{T} | | −D_{T} | |
| tion | tion | | | | | | | | | −U_{T} | |

| | | Sequence | |
|---|---|---|---|
| | Sequence | end of | |
| | real time | period | Basis for |
| Event | processing | processing | calculation |
| Premium | 1 | 2 | Pₜ″, rₑ₋ₜ, sₑ₋ₜ |
| Benefits | 6 | 3 | rₑ₋ₜ, sₜ₋₁ |
| | | | Bₜ″ = D*ₜ₋₁/10 |
| | | | \ddot{\dot{B}}ₜ″ = U*ₜ₋₁/10 |
| Update of | | 4 | D*ₜ₋₁, U*ₜ₋₁, |
| return on | | | r₁, s₁ |
| investment | | | |
| Transfer | | 5 | α, Uₜ |
| of α from | | | |
| RA to IA | | | |
| Termina- | 7 | | D_{T}, U_{T} |
| tion | | | |

Variable List to Table 2

Dₜ=The balance of the Individual Account at the time t

D_{T}=The balance of the Individual Account at the time T

Dₜ₋₁*=The opening balance of the Individual Account at the period starting with the time t−1

Uₜ=The balance of the Redistribution Account at the time t

U_{T}=The balance of the Redistribution Account at the time T

Uₜ₋₁*=The opening balance of the Redistribution Account at the period starting with the time t−1

α=Fixed percentage of the redistribution account to be transferred to the individual account

rₜ=Rate of return on the underlying assets in the period from t−1 to t

sₜ=The “long bond yield” in the period from t−1 to t

rₑ₋₁=Rate of return on the underlying assets in the period from tₑ to t

r₁₋ₑ=Rate of return on the underlying assets in the period from t−1 to tₑ

nₜ=Number of periods from the present to last benefit has been paid.

Pₜⁿ=Number n premium receipt from t−1 to t

Bₜⁿ=Number n benefit paid from t−1 to t

[symbol] ₜⁿ=Transfer from the Redistribution Account to the Risk Taker Account as a result of number n benefit paid from t−1 to t

The event catalogue defines the particular product as each field of the event catalogue specifies an action to be taken—in case an action is to be taking, of course. If no action is to be taken the field corresponding to that field is blank. For instance the first full row of the event catalogue of Table 2 specifies, i.e., that the amount +Pₜⁿ*Sₑ₋ₜ is transferred to the Individual account when the event premium having event type key business event occurs.

Illustrative Example 2a—Event Processing

To illustrate the function of the module for processing the events, an example based on the following initial conditions are considered:

A premium of a 1.000 has been received from the investor at the time tₑ and the premium has been recorded to the individual transaction account. The module for collecting premiums and payment of benefits has been applied for recording this transaction. Pₜ¹=1.000

Dₜ₋₁*=10.000

Uₜ₋₁*=2.000

α=20%

rₜ=20%

sₜ=10%

rₑ₋₁=10%

sₑ₋₁=5%

Now we will illustrate the functionality of the module for processing the event using the event catalogue when we are processing the time period form t−1 (not included) to t.

That means the programme has been asked to process all the events that have occurred from the time T_{begin}=(t−1)+dT (that will say t−1 is not included) to the time T_{end}=t.

Let's have a look at the various step the programme module for processing the events are going through.

Step b 1

First of all the programme module reads T_{begin} and T_{end} from the data storage for event processing information. Afterwards the programme sets the processing time T to T_{begin}.

Step 2

At step 2 we look up the data storage for event information to see whether any events have occurred at the time T.

If one or more events have occurred we proceed to step 3. If no events have occurred we proceed to step 4.

I this case lets say no events have occurred at the time T, so we will proceed to step 4.

Step 4

At step 4 we determine whether the time T is equal to T_{end}. If T is equal to T_{end} it is so it shows us that we have walked through the time period, which we have planned to go through, and we can proceed to step 5. If we have not reached time, T_{end}, we will go back to step 2—but first we will set the time T one step up to T+dT. And remember—dT could e.g. be one hour, one day one month etc, but normally dT will be one day. In this example we haven't reached T_{end} and T is set to T+dT and we proceed to step 2.

Step 2

Now—we are processing step 2 again, and the module reads the event information to see if any events have occurred at the new time T. Lets say that T=tₑ, and the module will find that our premium receipt event has occurred.

After the event has been found the programme module proceeds to step 3.

Step 3

The step first of all ensures that the event with the lowest sequence number is being processed first—in this case there are only one event occurring at the time tₑ.

Step 3 comprises four steps that are processed for each event and in this case four steps for the premium receipt event:

Step 3.1

This step determines the basis for the calculations. The module looks up the event catalogue, and finds the necessary data and formulas to process the event. In this case the module looks up “premium” and finds that the necessary basis comprises the premium received Pₜ^{t} as the event occurs at the real time tₑ. Then the module proceeds to step 3.2.

Step 3.2

At step 3.2 the module calculate the amounts to record at the various accounts. From the event catalogue it is seen that the premium Pₜ^{t} has to be recorded, without further calculations, to the individual account, the individual transaction account and the Investment Fund Account.

Then the module proceeds to step 3.3.

Step 3.3

At step 3.3 the amounts calculated will be debited or credited the various accounts. In this case the premium received, Pₜ¹=1.000, is credited the Individual Account and the Investment Fund Account, and debited the Individual Account. Please refer to Table 3 for the results at time tₑ.

Then the module proceeds to step 3.4

Step 3.4

This step checkmarks the event that has been processed in step 3. The recording of the checkmark is in this case made for the premium event at time tₑ in the data storage for individual event information. Now it is recorded that the premium received at the time te has been processed.

After step 3.4, step 3. is finalised and the programme module returns to step 2.

Step 2

Step 2 checks if there are any other unprocessed events at the time T—but as the premium receipt event was the only event at that time, the module proceeds to step 4 again.

Step 4—and step 2

At step 4 we determine whether the time T is equal to the T_{end}. In this case we have not reached T_{end}, and we will go back to step 2—but first we will set the time T one step up to T+dT.

And so the programme will carry on until it reaches the time T=t, where step 2 will find several unprocessed events:

the end of period processing of the premium receipt event

the processing of the update of the return on investment event

the processing of the transfer of α from RA to IA event

The programme module will then proceed to step 3 for processing the found events.

Step 3

First of all step 3 finds out that the end of period processing of the premium event has the lowest sequence number—so this event will be processed first.

Step 3.1

Step 3.1 finds from the event catalogue, that the basis for the calculation is the premium received Pₜ¹, the rate of return rₑ₋₁ and the “long bond yield”, sₑ₋₁. The values of the variables are found form the individual transaction account (the premium) and the investment performance information (the rates). The step then has the following values:

Pₜ¹=1.000

rₑ₋₁=10%

sₑ₋₁=5%

which forms the bases for the calculations in step 3.2.

Step 3.2

The step calculates on the found basis the amounts to be debited or credited to the various accounts. In this case the step finds:

that the amount of 50 is to be credited the Individual Account

that the amount of 50 is to be credited the Redistribution Account

Then the module proceeds to step 3.3.

Step 3.3

At step 3.3 the amounts calculated are credited the accounts. Please refer to Table 3 for the results for the premium receipt event at the time T=t.

Then the module proceeds to step 3.4

Step 3.4

Step 3.4 checkmarks the processed event. The recording of the checkmark is in this case made for the premium event at time t which is the end of period processing.

After step 3.4, step 3. is finalised and the programme module returns to step 2.

Step 2

Step 2 now finds that there are two unprocessed events:

the processing of the update of the return on investment event

the processing of the transfer of α from RA to IA event

The programme module will then proceed to step 3 for processing the found events.

Step 3

First of all step 3 finds out that the event concerning the update of the return of the investment has the lowest sequence number—so this event will be processed.

Step 3.1

Step 3.1 finds from the event catalogue, that the basis for the calculation is the opening balance of the Individual Account Dₜ*, the opening balance of the Redistribution Account Uₜ*. the rate of return rₜ and the “long bond yield” sₜ. The opening balances are found from the Individual and Redistribution Accounts, and the rates are found from the data storage for investment performance information. The step then has the following values:

Dₜ₋₁*=10.000

Uₜ₋₁*=2.000

rₜ=20%

sₜ=10%

which now forms the basis for the calculations in step 3.2.

Step 3.2

The step calculates, on the found basis, the amounts to be debited or credited to the various accounts. In this case the step finds:

that the amount of 1.000 is to be credited the Individual Account

that the amount of 1.400 is to be credited the Redistribution Account

Then the module proceeds to step 3.3.

Step 3.3

At step 3.3 the amounts calculated are credited the accounts. Please refer to Table 3 for the results on the update of the accounts.

Then the module proceeds to step 3.4

Step 3.4

Step 3.4 checkmarks the processed event. The recording of the checkmark is in this case made for the update of the rate of return event at time t which is the end of period processing.

After step 3.4, step 3. is finalised and the programme module returns to step 2.

Step 2

Step 2 now finds that there is only one unprocessed event at the time T:

the processing of the transfer of α from RA to IA event.

The programme module will then proceed to step 3 for processing the found event.

Step 3

First of all step 3 finds out that the event concerning the transfer of α from RA to IA has the lowest sequence number—it is the only event. The event will then be processed.

Step 3.1

Step 3.1 finds from the event catalogue, that the basis for the calculations are the balance of the Individual Account Dₜ, the balance of the Redistribution Account Uₜ, and the transfer rate α. The balances are found from the Individual and Redistribution Accounts, and the transfer rate from the product information. The step then has the following values:

Dₜ=12.050

Uₜ=3.450

α=20%

which now forms the basis for the calculations in step 3.2.

Step 3.2

The step calculates, on the found basis, the amounts to be debited or credited to the various accounts. In this case the step finds:

that the amount of 690 is to be credited the Individual Account

that the amount of 690 is to be debited the Redistribution Account

Then the module proceeds to step 3.3.

Step 3.3

At step 3.3 the amounts calculated are credited the accounts. Please refer to Table 3 for the results on the transfer from RA to IA.

Then the module proceeds to step 3.4

Step 3.4

Step 3.4 checkmarks the processed event. The recording of the checkmark is in this case made for the transfer from RA to IA event at time t, which is the end of period processing.

After step 3.4, step 3. is finalised and the programme module returns to step 2.

Step 2

Step 2 finds that there are no unprocessed events at the time T. The module then proceeds to step 4.

Step 4

Step 4 checks T is equal to the T_{end}. As we have defined the time period to process finalises at the time T_{end}=t, we can proceed to step 5.

Step 5

At step 5 we write to the data storage for event processing information that we have finalised the time period from T=T_{begin} to T=T_{end}.

After step 5 the event processing terminates.

TABLE 3.
The results of the transactions are shown in the table below

| | | Account | | | | | | |
|---|---|---|---|---|---|---|---|---|
| | | Individual | | | | | Individual | Investment |
| | | Account | | Redistribution | | Risk Taker | Trans. | Fund |
| | | (IA) | | Account (RA) | | Account | Account | Account |
| Event | Time | Trans | Balance | Trans | Balance | Trans | Trans | Trans |
| | t − 1 | | 10.000 | | 2.000 | | | |
| Premium | tₑ | +1.000 | | | | | −1.000 | +1.000 |
| Premium | t | +50 | | +50 | | | | |
| (end of | | | | | | | | |
| period) | | | | | | | | |
| Update of | t | +1.000 | 12.050 | +1.400 | 3.450 | | | |
| return on | | | | | | | | |
| investment | | | | | | | | |
| Transfer of | t | +690 | 12.740 | −690 | 2.760 | | | |
| α from RA | | | | | | | | |
| to IA | | | | | | | | |

Table 3. The table shows the transactions on the various accounts related to the above example:

First of all the table shows that the balance of IA and RA at the time T=t−1 is 10.000 and 2.000.

When the premium is received at the time to 1.000 is credited to IA, 1.000 debited individual transaction account and 1.000 credited the Investment Fund.

At the end of period processing of the premium at the time t, 50 is credited IA and RA.

At the end of period processing of the update of the return on investment at the time t, 1.000 is credited IA and 1.400 is credited RA. The balance of IA and RA is now 12.050 and 3.450.

At the end of period processing of the transfer of α from RA to IA event at the time t, 690 is credited IA and 690 is debited RA. The balance of IA and RA is now 12.740 and 2.760, which actually forms the opening balance for the new period after t.

Illustrative Example 2b—Event Processing

To illustrate the function of the module for processing the events, this example is based on the event catalogue in Table 2 and the on the following initial conditions:

Benefit is paid to the investor at the time tₑ

Dₜ₋₁*=10.000

Uₜ₋₁*=2.000

α=20%

rₜ=20%

sₜ=10%

rₑ₋₁=10%

sₑ₋₁=5%

This example shows how benefits paid at the time tₑ will effect the accounts in the time period from t−1 to t

TABLE 4

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Benefit | tₑ | −1.000 | | −200 | | +200 | +1.000 | −1.000 |
| Benefit (end | T | −50 | | −70 | | | | |
| of period) | | | | | | | | |
| Update of | T | +1.000 | 9.950 | +1.400 | 3.330 | | | |
| return on | | | | | | | | |
| investment | | | | | | | | |
| Transfer of | T | +666 | 10.616 | −666 | 2.664 | | | |
| α from RA | | | | | | | | |
| to IA | | | | | | | | |

The table shows the transactions on the various accounts related to the above example:

First of all the table shows that the balance of IA and RA at the time T=t−1 is 10.000 and 2.000.

When the benefit is paid at the time tₑ 1.000 is debited IA, 200 is debited RA, 200 is credited the Risk Taker account, 1000 is credited the Individual transaction Account and 1000 is debited the Investment Fund Account.

At the end of period processing of the benefit at the time t, 50 is debited IA and 70 is debited RA.

At the end of period processing of the update of the return on investment at the time t, 1.000 is credited IA and 1.400 is credited RA. The balance of IA and RA is now 9.950 and 3.330.

At the end of period processing of the transfer of α from RA to IA event at the time t, 666 is credited IA and 666 is debited RA. The balance of IA and RA is now 10.616 and 2.664, which actually forms the opening balance for the new period after t.

Illustrative Example 2c—Event Catalogue

To illustrate the function of the module for processing the events, this example is based on the event catalogue in Table 2 and the on the following initial conditions:

The agreement with the investor is terminated at the time tₑ.

Dₜ₋₁*=10.000

Uₜ₋₁*=2.000

α=20%

This example shows how the termination at the time tₑ will effect the accounts in the time period from t−1 to t.

TABLE 5

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Termination | tₑ | −10.000 | 0 | −2.000 | 0 | +2.000 | +10.000 | −10.000 |

The table shows the transactions on the various accounts related to the above example:

First of all the table shows that the balance of IA and RA at the time T=t−1 is 10.000 and 2.000.

When the agreement is terminated at the time tₑ 10.000 is debited IA, 2.000 is debited RA, 2.000 is credited the Risk Taker account, 10.000 is credited the Individual transaction Account and 10.000 is debited the Investment Fund Account. The balance of IA and RA is nil

Illustrative Example 3—Event Processing—Lump Sum Benefit

In the following an illustrative example of how the computer system, according to the present invention works upon execution, is put forward. The example is an implementation which relates to the characteristics in the illustrative example 1.c in the previous section.

As shown in Table 6 the product defined in the event catalogue comprises five different events: Payment of premiums, payment of benefits, update of accounts, transferral of the redistribution account to the Individual Account and termination of the contract.

TABLE 6

| | | Account | | | | | | | | | |
|---|---|---|---|---|---|---|---|---|---|---|---|
| | | | | | | | | | | Investment Fund | |
| | | | | | | | | Individual Transaction | | Account | |
| | | | | | | Risk Taker Account | | Account | | | End |
| | | Individual Account | | Redistribution Account | | | End of | | End of | | of |
| Event | Type | Real | End of period | Real | End of period | Real | period | Real | period | Real | period |
| Premium | Key | +Pⁿₜ | +Pⁿₜ*sₑ₋ₜ | | +Pⁿₜ*(rₑ₋ₜ−sₑ₋ₜ₎ | | | −Pⁿₜ | | +Pⁿₜ | |
| | business | | | | | | | | | | |
| | event | | | | | | | | | | |
| Benefits | Termi- | −B | | −\ddot{\dot{B}} | | +\ddot{\dot{B}} | | +B | | −B | |
| | nation | | | | | | | | | | |
| Update of | Regular | | +D*ₜ₋₁ * sₜ | | +D* ₜ₋₁ * (rₜ − sₜ) | | | | | | |
| return on | event | | | | +U*ₜ₋₁*rₜ | | | | | | |
| investment | | | | | | | | | | | |
| Transfer of | Regular | | +α * (1 + rₜ) * | | −α * (1+r)ₜ * | | | | | | |
| α from RA | event | | U*ₜ₋₁ | | U* ₜ₋₁ | | | | | | |
| to IA | | | | | | | | | | | |
| Termination | Termin- | −Dₜ | | −Uₜ | | +(1 − Cₜ) * | | +Dₜ | | −Dₜ | |
| | ation | | | | | Uₜ | | +Cₜ * Uₜ | | −Cₜ * Uₜ | |

| | | Sequence | Sequence | |
|---|---|---|---|---|
| | | real time | end of period | |
| Event | Type | processing | processing | Basis for calculation |
| Premium | Key | 1 | 2 | Pⁿₜ,rₑ₋ₜ, sₑ₋ₜ |
| | business | | | |
| | event | | | |
| Benefits | Termi- | | 5 | B = D_{T} |
| | nation | | | \ddot{\dot{B}} = U_{T} |
| Update of | Regular | | 3 | D*ₜ₋₁, U*ₜ₋₁, rₜ,sₜ |
| return on | event | | | |
| investment | | | | |
| Transfer of | Regular | | 4 | α,Uₜ |
| α from RA | event | | | |
| to IA | | | | |
| Termina- | Termi- | 6 | | Dₜ,Uₜ |
| tion | nation | | | Cₜ = 1 − (1 − α)ⁿₜ |

Variable List for Table 6

Dₜ=The balance of the Individual Account at the time t

D_{T}=The balance of the Individual Account at the time T

Dₜ₋₁*=The opening balance of the Individual Account at the period starting with the time t−1

Uₜ=The balance of the Redistribution Account at the time t

Uₜ=The balance of the Redistribution Account at the time T

Uₜ₋₁*=The opening balance of the Redistribution Account at the period starting with the time t−1

α=Fixed percentage of the redistribution account to be transferred to the individual account

rₜ=Rate of return on the underlying assets in the period from t−1 to t

sₜ=The “long bond yield” in the period from t−1 to t

rₑ₋₁=Rate of return on the underlying assets in the period from tₑ to t

r₁₋ₑ=Rate of return on the underlying assets in the period from t−1 to tₑ

Pₜⁿ=Number n premium receipt from t−1 to t

B=Number n benefit paid from t−1 to t

[symbol] =Transfer from the Redistribution Account to the Risk Taker Account as a result of benefit paid

Illustrative Example 3a—Event Processing—Lump sum benefit

To illustrate the function of the module for processing the events, this example is based on the event catalogue in Table 6 and the on the following initial conditions:

Premium is received from the investor at the time tₑ prior to the time t

Dₜ₋₁*=10.000

Uₜ₋₁*=2.000

α=20%

rₜ=20%

sₜ=10%

rₑ₋₁=10%

sₑ₋₁=5%

Pₜ^{t}=1.000

TABLE 7

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Premium | tₑ | +1.000 | | | | | −1.000 | +1.000 |
| Premium | T | +50 | | +50 | | | | |
| (end of | | | | | | | | |
| period) | | | | | | | | |
| Update of | T | +1.000 | 12.050 | +1.400 | 3.450 | | | |
| return on | | | | | | | | |
| investment | | | | | | | | |
| Transfer of | T | +480 | 12.530 | −480 | 2.970 | | | |
| α from RA | | | | | | | | |
| to IA | | | | | | | | |

The table shows the transactions on the various accounts related to the above example:

First of all the table shows that the balance of IA and RA at the time T=t−1 is 10.000 and 2.000.

When the premium is received at the time tₑ 1.000 is credited to IA, 1.000 debited individual transaction account and 1.000 credited the Investment Fund.

At the end of period processing of the premium at the time t, 50 is credited IA and RA.

At the end of period processing of the update of the return on investment at the time t, 1.000 is credited IA and 1.400 is credited RA. The balance of IA and RA is now 12.050 and 3.450.

At the end of period processing of the transfer of α from RA to IA event at the time t, 690 is credited IA and 690 is debited RA. The balance of IA and RA is now 12.740 and 2.760, which actually forms the opening balance for the new period after t.

Illustrative Example 3b—Event Processing—Lump Sum Benefits

To illustrate the function of the module for processing the events, this example is based on the event catalogue in Table 6 and the on the following initial conditions:

Benefit is paid to the investor at the time tₑ=t

Dₜ₋₁*=10.000

Uₜ₋₁*=2.000

α=20%

rₜ=20%

sₜ=10%

rₑ₋₁=10%

sₑ₋₁=5%

nₜ=2

TABLE 8

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Update of | T | +1.000 | 11.000 | +1.400 | 3.400 | | | |
| return of | | | | | | | | |
| investment | | | | | | | | |
| Transfer of | T | +480 | 11.480 | −480 | 2.920 | | | |
| α from RA | | | | | | | | |
| to IA | | | | | | | | |
| Benefit (real | tₑ = t | −11.480 | 0 | −2.920 | 0 | +2.920 | +11.480 | −11.480 |
| time and | | | | | | | | |
| end of | | | | | | | | |
| period) | | | | | | | | |

The table shows the transactions on the various accounts related to the above example:

First of all the table shows that the balance of IA and RA at the time T=t−1 is 10.000 and 2.000.

At the end of period processing of the update of the return on investment at the time t, 1.000 is credited IA and 1.400 is credited RA. The balance of IA and RA is now 11.000 and 3.400.

At the end of period processing of the transfer of α from RA to IA event at the time t, 480 is credited IA and 480 is debited RA. The balance of IA and RA is now 11.480 and 2.920, which actually forms the balance that is basis for the benefit end of period.

When the benefit is paid at the time T=t=tₑ, 11.480 is debited IA, 2.920 is debited RA, 2.920 is credited the Risk Taker account, 11.480 is credited the Individual transaction Account and 11.480 is debited the Investment Fund Account.

Illustrative Example 3c—Event Catalogue—Lump Sum Benefit

To illustrate the function of the module for processing the events, this example is based on the event catalogue in Table 6 and the on the following initial conditions:

The agreement with the investor is terminated at the time tₑ.

Dₜ₋₁*=10.000

Uₜ₋₁*=2.000

α=20%

nₜ=2

This example shows how the termination at the time tₑ will effect the accounts in the time period from t−1 to t.

TABLE 9

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Termination | tₑ | −10.000 | 0 | −2.000 | 0 | +1.280 | +10.720 | −10.720 |

The table shows the transactions on the various accounts related to the above example:

First of all the table shows that the balance of IA and RA at the time T=t−1 is 10.000 and 2.000.

When the agreement is terminated at the time tₑ 10.000 is debited IA, 2.000 is debited RA, 1.280 is credited the Risk Taker account, 10.720 is credited the Individual transaction Account and 10.720 is debited the Investment Fund Account. The balance of IA and RA is nil

Illustrative Example 4—Event Processing—Benefits by Installments

In the following an illustrative example of how the computer system, according to the present invention works upon execution, is put forward. The example is an implementation, which relates to the characteristics in the illustrative example 1.e in the previous section.

As shown in Table 10 the product defined in the event catalogue comprises five different events: Payment of premiums, payment of benefits, update of accounts, transferral of the redistribution account to the Individual Account and termination of the contract.

TABLE 10

| | | Account | | | | | | | | | |
|---|---|---|---|---|---|---|---|---|---|---|---|
| | | | | | | | | | | Investment Fund | |
| | | | | | | | | Individual Transaction | | Account | |
| | | | | | | Risk Taker Account | | Account | | | End |
| | | Individual Account | | Redistribution Account | | | End of | | End of | | of |
| Event | Type | Real | End of period | Real | End of period | Real | period | Real | period | Real | period |
| Premium | Key | +Pⁿₜ | +Pⁿₜ*sₑ₋ₜ | | +Pⁿₜ*(rₑ₋ₜ−sₑ₋ₜ₎ | | | −Pⁿₜ | | +Pⁿₜ | |
| | business | | | | | | | | | | |
| | event | | | | | | | | | | |
| Benefits | Key | −B″ₜ | −\ddot{\dot{B}}″ₜ*sₑ₋ₜ | −\ddot{\dot{B}}″ₜ | −B″ₜ*(rₑ₋ₜ− sₑ₋ₜ) | +B″ₜ | | +B″ₜ | | −B″ₜ | |
| | business | | | | −B″ₜ * rₑ₋ₜ | | | | | | |
| | event | | | | | | | | | | |
| Update of | Regular | | +D*ₜ₋₁ * sₜ | | +D*ₜ₋₁ * (rₜ −sₜ) | | | | | | |
| return on | event | | | | +U′ₜ₋₁ * rₜ | | | | | | |
| investment | | | | | | | | | | | |
| Transfer of | Regular | | +α * (1+rₜ) * | | − α*(1 + r)ₜ * | | | | | | |
| α from RA | event | | U*ₜ₋₁ | | U′ₜ₋₁ | | | | | | |
| to IA | | | | | | | | | | | |
| Termination | Termin- | −D_{T} | | −U_{T} | | +(1−Cₜ) * U_{T} | | +D_{T} | | −D_{T} | |
| | ation | | | | | | | +Cₜ * U_{T} | | −Cₜ * U_{T} | |

| | | | Sequence | |
|---|---|---|---|---|
| | | Sequence | end of | |
| | | real time | period | |
| Event | Type | processing | processing | Basis for calculation |
| Premium | Key | 1 | 2 | P″ₜ, rₑ₋ₜ, sₑ₋ₜ |
| | business | | | |
| | event | | | |
| Benefits | Key | 6 | 3 | rₑ₋ₜ, sₜ₋₁ |
| | business | | | B″ₜ = |
| | event | | | D_{T}/(n_{TOT} + 1−n″ₜ) |
| | | | | \ddot{\dot{B}}″ₜ= |
| | | | | U_{T}/(n_{TOT} + 1−n″ₜ) |
| Update of | Regular | | 4 | D*ₜ₋₁,U*ₜ₋₁,rₜ,Sₜ |
| return on | event | | | |
| investment | | | | |
| Transfer of | Regular | | 5 | α,U′ₜ₋₁,rₜ |
| α from RA | event | | | |
| to IA | | | | |
| Termination | Termin- | 7 | 8 | D_{T},U_{T} |
| | ation | | | Cₜ = 1 − (1−α)ⁿₜ |

Variable List for Table 10

Dₜ=The balance of the Individual Account at the time t

D_{T}=The balance of the Individual Account at the time T

Dₜ₋₁*=The opening balance of the Individual Account at the period starting with the time t−1

Uₜ=The balance of the Redistribution Account at the time t

Uₜ=The balance of the Redistribution Account at the time T

Uₜ₋₁*=The opening balance of the Redistribution Account at the period starting with the time t−1

α=Fixed percentage of the redistribution account to be transferred to the individual account

rₜ=Rate of return on the underlying assets in the period from t−1 to t

sₜ=The “long bond yield” in the period from t−1 to t

rₑ₋₁=Rate of return on the underlying assets in the period from tₑ to t

r₁₋ₑ=Rate of return on the underlying assets in the period from t−1 to tₑ

nₜ=Number of periods form the present to last benefit has been paid.

Pₜⁿ=Number n premium receipt from t−1 to t

Bₜⁿ=Number n benefit paid from t−1 to t

[symbol] ₜⁿ=Transfer from the Redistribution Account to the Risk Taker Account as a result of number n benefit paid from t−1 to t

n₁ⁿ=The number of benefit paid. The number is related to the number n payment in the time period from t−1 to t.

n_{TOT}=The total number of benefits to pay.

Illustrative Example 4a—Event Processing—Benefits by Installments

To illustrate the function of the module for processing the events, this example is based on the event catalogue in Table 10 and the on the following initial conditions:

Benefit is paid to the investor at the time tₑ

Dₜ₋₁*=10.000

Uₜ₋₁*=2.000

α=20%

rₜ=20%

sₜ=10%

rₑ₋₁=10%

sₑ₋₁=5%

TABLE 11

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Premium | tₑ | +1.000 | | | | | −1.000 | +1.000 |
| Premium | t | +50 | | +50 | | | | |
| (end of | | | | | | | | |
| period) | | | | | | | | |
| Update of | t | +1.000 | 12.050 | +1.400 | 3.450 | | | |
| return on | | | | | | | | |
| investment | | | | | | | | |
| Transfer of | t | +480 | 12.530 | −480 | 2.970 | | | |
| α from RA | | | | | | | | |
| to IA | | | | | | | | |

The table shows the transactions on the various accounts related to the above example:

First of all the table shows that the balance of IA and RA at the time T=t−1 is 10.000 and 2.000.

When the premium is received at the time tₑ 1.000 is credited to IA, 1.000 debited individual transaction account and 1.000 credited the Investment Fund.

At the end of period processing of the premium at the time t, 50 is credited IA and RA.

At the end of period processing of the update of the return on investment at the time t, 1.000 is credited IA and 1.400 is credited RA. The balance of IA and RA is now 12.050 and 3.450.

At the end of period processing of the transfer of a from RA to IA event at the time t, 480 is credited IA and 480 is debited RA. The balance of IA and RA is now 12.530 and 2.970, which actually forms the opening balance for the new period after t.

Illustrative Example 4b—Event Processing—Benefits by Installments

To illustrate the function of the module for processing the events, this example is based on the event catalogue in Table 10 and the on the following initial conditions:

Benefit is paid to the investor at the time tₑ

Dₜ₋₁*=10.000

Uₜ₋₁*=2.000

α=20%

rₜ=20%

sₜ=10%

rₑ₋₁=10%

sₑ₋₁=5%

nₜⁿ=7

N_{TOT}=10

This example shows how benefits paid at the time tₑ will effect the accounts in the time period from t−1 to t

TABLE 12

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Benefit | tₑ | −2.500 | | −500 | | +500 | +2.500 | −2.500 |
| Benefit (end | t | −125 | | −175 | | | | |
| of period) | | | | | | | | |
| Update of | t | +1.000 | 8.375 | +1.400 | 2.725 | | | |
| return of | | | | | | | | |
| investment | | | | | | | | |
| Transfer of | t | +480 | 8.855 | −480 | 2.245 | | | |
| α from RA | | | | | | | | |
| to IA | | | | | | | | |

The table shows the transactions on the various accounts related to the above example:

First of all the table shows that the balance of IA and RA at the time T=t−1 is 10.000 and 2.000.

When the benefit is paid at the time tₑ, 2.500 is debited IA, 50 is debited RA, 500 is credited the Risk Taker account, 2.500 is credited the Individual transaction Account and 2.500 is debited the Investment Fund Account.

At the end of period processing of the benefit at the time t, 125 is debited IA and 175 is debited RA.

At the end of period processing of the update of the return on investment at the time t, 1.000 is credited IA and 1.400 is credited RA. The balance of IA and RA is now 8.375 and 2.725.

At the end of period processing of the transfer of α from RA to IA event at the time t, 480 is credited IA and 480 is debited RA. The balance of IA and RA is now 8.855 and 2.245, which actually forms the opening balance for the new period after t.

Illustrative example 4c—Event Catalogue—Benefits by Installments

To illustrate the function of the module for processing the events, this example is based on the event catalogue in Table 10 and the on the following initial conditions:

The agreement with the investor is terminated at the time tₑ.

Dₜ₋₁*=10.000

Uₜ₋₁*=2.000

α=20%

nₜ=4

This example shows how the termination at the time tₑ will effect the accounts in the time period from t−1 to t

TABLE 13

| | | Account | | | | | | |
|---|---|---|---|---|---|---|---|---|
| | | | | | | | Individual | Investment |
| | | Individual Account | | Redistribution | | Risk Taker | Transaction | Fund |
| | | (IA) | | Account (RA) | | Account | Account | Account |
| Event | Time | Trans | Balance | Trans | Balance | Trans | Trans | Trans |
| | t−1 | | 10.000 | | 2.000 | | | |
| Termination | tₑ | −10.000 | 0 | −2.000 | 0 | +819 | +11.181 | −11.181 |

The table shows the transactions on the various accounts related to the above example:

First of all the table shows that the balance of IA and RA at the time T=t−1 is 10.000 and 2.000.

When the agreement is terminated at the time tₑ 10.000 is debited IA, 2.000 is debited RA, 819 is credited the Risk Taker account, 11.181 is credited the Individual transaction Account and 11.181 is debited the Investment Fund Account. The balance of IA and RA is zero.

1. A data processing system, such as a computer system, for administering at least one individual account, at least one redistribution account and a risk taker account, each redistribution account being linked to an individual account and to the risk taker account, said accounts being preferably represented in the computer system as one or more account databases, and said administering being controlled by events, preferably being stored in and retrieved from an event database storing instances of events; said events effecting money transfers between the accounts preferably by entering and/or altering records in the account databases, said system comprising:
an event catalogue, preferably in the form of a database, storing transaction rules for money transfers between said accounts; to each event being assigned, if existing, a specific transaction rule for the case the event occur real time and a specific rule for the case the event occur at the end of a considered time window; processor means for retrieving from the event database events instances occurred within a particular time window and for, based on the retrieved events instances, identifying the affected rules;
processor means for executing the affected rules in accordance with theirs possible mutual dependency thereby depositing an investor's investments on an individual account and/or transferring an amount between the redistribution account and the individual account and/or transferring the amount of the redistribution account to the risk taker in accordance with the events occurred within the time window considered.

2. A data processing system according to claim 1, wherein events are grouped into administration type events being selected from the group of types consisting of key business type events, being events which occur at a non-predefined time, and regular type events, being events occurring at predefined instants and grouped into termination type events being event terminating the administering of the accounts.

3. A data processing system according to claim 1, further comprising event storage means storing in the event database each event that has occurred and the time each event occurred in a time window.

4. A data processing system according to claim 1, wherein the event catalogue is storing or further storing transactions rules as function of account and event.

5. A data processing system according to claim 5, wherein the mutual dependency between rules stored in the event catalogue is stored as a sequence number for each transaction rule selected to have a sequence number assigned, said sequence number dictating a particular sequence for executing rules in case an event results in execution of more than one rule and/or in case two or more events occur simultaneously so that more than one rule are to be executed.

6. A data processing system according to claim 5, wherein all transaction rules stored in the event catalogue storage means are selected to have a sequence number assigned.

7. A data processing system according to claim 5, comprising processor means being adapted to
establish, preferably by reading from a data storage, begin and end time (T_{begin}; T_{end}) of a processing time window in which processing of events instances is to be performed;
establish, preferably by reading from the event database, events instances that have occurred, if any, and which relates to rules to be executed, and the time the events occurred within said processing time window;
execute the rules corresponding to the established events instances, if any, in the order defined by the sequence number of the rules and/or in succession by the time the established events occurred.

8. A data processing system according to claim 7, wherein the processing means is(are) further adapted to
step through the processing time windows with a predetermined time increment, dT, thereby defining time spots in the processing time window;
establish, at each time spot, preferably by reading from the event database, events that have occurred, if any, in a time frame defined by the latest time spot considered and the time spot in question; and
at each time spot execute rules corresponding to the established events, if any, in the order defined by the sequence number of the rules to be executed.

9. A data processing means according to claim 7, wherein said event processing means further is adapted to treat two or more events as having occurred simultaneously in case said two or more events occur within a time frame defined by the latest time spot considered and a time spot in question.

10. A data processing system according to claim 1, wherein said processing means is further adapted to check mark an event instance when the rule(s) corresponding to the event instance has(have) been executed.

11. A data processing system according to claim 7, wherein the processing means further being adapted
to read, during execution of a transaction rule, from one or more storage a basis for transaction rule, such as read from the event catalogue the variable(s) being involved in execution of the transaction rule, such as a rate of return, and reading from another storage the value(s) of the variable(s);
to manipulate, during execution of a transaction rule, the basis for the calculation(s) in accordance with the transaction rule thereby determining one or more amount to credited and/or debited on one or more account(s); and,
during execution of a transaction rule, to debit and/or to credit the amounts determined in accordance with the transaction rule.

12. A data processing system according to claim 11, wherein the processing means is(are) further adapted to obtain and maintain a log file storing all debiting and crediting performed.

13. A data processing system according to claim 11, wherein the check marking of an event is done after all crediting and/or debiting effectuated by the event has(have) been performed.

14. A data processing system according to claim 7, further comprising an event processing information storage and wherein the event processing means is(are) further adapted to store in said event processing storage the begin time and end time of a time window after events occurred within said time window has been processed.

15. A data processing system according to claim 7, further comprising a product information storage storing information on product characteristics, such as percentage of the redistribution account to be transferred to the individual account, such as number of benefits to be transferred to be disbursed to the investor, parameters for cost calculations and the like.

16. A data processing system according to claim 15, wherein the some or all value(s) of the variable(s) of the basis of the calculations is(are) read from the product information storage.

17. A data processing system according to claim 7, further comprising an investor agreement information storage storing for each of a plurality of investors information on a particular product assigned to a particular investor and wherein the data processing system is adapted to before initiation of event processing for a particular investor read from the investor agreement information storage information on the particular product assigned to the particular investor so that the event processing for a particular investor is based upon the product assigned to said particular investor.

18. A data processing system according to claim 1, further comprising an individual event information storage storing for each investor all events that are related thereto.

19. A data processing system according to claim 1, further comprising a common event information storage storing event being common for all investors.

20. A data processing system according to claim 1, wherein the individual account(s), the redistribution account(s) and the risk taker account comprises records on debit and credit transactions made on the accounts.

21. A data processing system according to claim 20, wherein the data processing system is adapted to determine the balances of the individual account(s), the redistribution account(s) and the risk taker account by summing all the transactions made on the accounts.

22. A data processing system according to claim 1, wherein the data processing system further comprising an individual transaction account in the form of a storage linked to each individual account of the data processing system, the individual transaction account records all transactions made between the investor and the administrator, such as all premiums paid by the investor and all benefits the administrator is disbursing.

23. A data processing system according to claim 22, wherein the data processing system is adapted to determine the balance of the individual transaction account by summing all transactions made on the account.

24. A data processing system according to claim 1, wherein the data processing system further comprising an investment fund account represented as a data storage storing records on investments made in underlying assets of the amounts of the individual account(s), the redistribution account(s) and the risk taker account, said records preferably comprise identification of the financial instruments invested in, trading information and/or market value.

25. A data processing system according to claim 1, wherein the data processing system further comprising an investment performance information storage storing information on the performance of the investments made in the underlying assets of the amounts of the individual account(s), the redistribution account(s) and the risk taker account, the information preferably comprises the returns of the investments made, expected returns of the investments made and/or interest rates.

26. A data processing system according to claim 1, wherein the system comprises a plurality of individual accounts, a redistribution account linked to each individual account and one risk taker account linked to the plurality of individual accounts and the redistribution accounts.

27. A computerised method for administering investments made by an investor, said method is controlled by events initiating money transfers between at least one individual account and at least one redistribution account linked to the individual account, and between a risk taker account, linked to the redistribution account(s), and the at least one redistribution account, wherein said accounts being represented in a computer system as data storages, said method comprising performing the following steps in a computer:
depositing the investor's investments on an individual account when an administration type event occur,
transferring an amount between the redistribution account and the individual account when an administration type event occur, and
transferring the amount of the redistribution account to a risk taker account when a termination type event occurs.

28. A method according to claim 27, wherein the investor's investments are invested in underlying assets.

29. A method according to claim 27, wherein the amount of the redistribution account is invested in underlying assets.

30. A method according to claim 27, wherein each of the at least one individual account is assigned to, such as owned solely by, the individual and wherein each of the at least one redistribution account is assigned to, such as owned solely by, the individual.

31. A method according to claim 27, wherein the risk taker account is assigned to, such as owned solely by, a risk taker, which risk taker is a different entity than the individual, such as second investor.

32. A method according to claim 27, wherein the risk taker account is assigned to a plurality of redistribution accounts.

33. A method according to claim 27, wherein step of transferring an amount between the individual account and the redistribution account comprises the steps of transferring
from the individual account a return (r*D) of the individual account to the redistribution account, and transferring
from the redistribution account an amount equal a modified return (s*D) of the individual account to the individual account.

34. A method according to claim 27, wherein the step of transferring an amount between the individual account and the redistribution account comprises the steps of
determining the difference between a return (r*D) of the individual account and a modified return of the individual account (s*D) and
transferring this difference between the individual account and the redistribution account.

35. A method according to claim 27, wherein the return is determined on the basis of the amount present on the individual account before one or more administration events occur effecting one or more transfers from and to the individual account.

36. A method according to claim 27, wherein the step of transferring an amount between the individual account and the redistribution account further comprises the step of
transferring a proportion of the amount of the redistribution account to the individual account.

37. A method according to claim 36, wherein the proportion is determined on the basis of the amount present on the redistribution account before one or more administration events occur effecting transfers from and to the redistribution account and to the individual account.

38. A method according to claim 36, wherein the amount of the redistribution account, of which the proportion is taken, is the amount present on the redistribution account before the return of the individual account (r*D) is transferred to the redistribution account and before the modified return (s*D) is transferred from the redistribution account and to the individual account.

39. A method according to claim 36, wherein the proportion is determined on the basis of the amount present on the redistribution account after one or more administration events occurred having effected transfers from and to the redistribution account and to the individual account.

40. A method according to claim 36, wherein the amount of the redistribution account, of which the proportion is taken, is the amount present on the redistribution account after the return of the individual account (r*D) is transferred to the redistribution account and after the modified return (s*D) is transferred from the redistribution account and to the individual account.

41. A method according to claim 36, wherein the proportion is a fraction, α, of the amount on the redistribution account, which fraction depends in general on the past scenarios.

42. A method according to claim 36, wherein the fraction is constant, such as substantially constant, during one or more time periods.

43. A method according to claim 42, wherein the fraction is constant during the duration of a contract made between the investor and the administrator of the method.

44. A method according to claim 41, wherein the fraction, α, is smaller than 1.

45. A method according to claim 27, further comprising the step of ceiling the transfer from redistribution account to the individual account.

46. A method according to claim 45, wherein the ceiling is determined by bounding the proportion transferred from the redistribution account to the individual account.

47. A method according to claim 41, further comprising the step of determining the fraction, α, by a functional relationship securing a guaranteed return (g) on the individual account.

48. A method according to claim 47, wherein the functional relationship determines the fraction, α, so that it decreases when the amount on the redistribution account becomes smaller than a predefined amount.

49. A method according to claim 47, wherein the functional relationship determines the fractions, α, so that it increases when the amount on the redistribution account becomes larger than a predefined amount.

50. A method according to claim 47, wherein the functional relationship bounds the fraction to be
α_{g.t}=min(α,(sₜ−g)D*ₜ₋₁/|Uₜ|).

51. A method according to claim 27, further comprising the step of transferring an amount, β, of the redistribution account to the risk taker account when an administration event occur.

52. A method according to claim 51, wherein the amount, β, of the redistribution account to be transferred to the risk taker account is set according to a contract made between the investor and the administrator.

53. A method according to claim 27, further comprising the step of determining an pay out amount of the individual account and transferring this pay out amount to the investor assigned to the individual account.

54. A method according to claim 53, wherein the step of determining an pay out amount and transferring the amount to the investor only is executed in a time period ending when a termination event occur.

55. A method according to claim 27, wherein the time when the termination event occur is deterministic.

56. A method according to claim 27, wherein the time when the termination event occur is stochastic.

57. A method according to claim 27, wherein an administration type event is selected from the group of types consisting of key business type event being events which occur at a non-predefined time and regular type event being events occurring at predefined instants.

58. A method according to claim 27, further comprising the step of storing in an event storage means, preferably being a database, each event occurred in a time window and the time each event occurred.

59. A method according to claim 27, wherein the transfers are effectuated by processing events, which processing comprising
establishing, preferably by reading from a data storage, begin and end time (T_{begin}; T_{end}) of a processing time window in which processing of events is to be performed;
establishing, preferably by reading from event data storage means events occurred within in said processing time window, if any, and the time the events occurred within said processing time window and which relates to rules to be executed;
consulting an event catalogue and establishing rules corresponding established events, if any; said event catalogue preferably being a database storing transactions rules as function of account and event and a sequence number for each transaction rule selected to have a sequence number assigned, said sequence number dictates a particular sequence for executing rules in case an event results in execution of more than one rule and/or in case two or more events occur simultaneously so that more than one rule are to be executed,
executing the established rules, if any, in the order defined by the sequence number of the rules and/or in succession by the time the established events occurred.

60. A method according to claim 59, wherein all transaction rules stored in the event catalogue storage means are selected to have a sequence number assigned.

61. A method according to claim 59, wherein, wherein said event processing further comprising
stepping through the processing time windows with a predetermined time increment, dT, thereby defining time spots in the processing time window;
establishing at each time spot, preferably by reading from the event data storage means, events occurred, if any, in a time frame defined by the latest time spot considered and the time spot in question; and
executing at each time spot rules corresponding to the established events, if any, in the order defined by the sequence number of the rules to be executed.

62. A method according to claim 61, further comprising the step of defining two or more events to have occurred simultaneously in case said two or more events occur within a time frame defined by the latest time spot considered and a time spot in question.

63. A method according to claim 59, further comprising the step of check marking an event when the rule(s) corresponding to the event has(have) been executed.

64. A method according to claim 59, wherein the step of executing a transaction rule further comprising the steps of
reading from one or more storages a basis for transaction rule, such as reading from the event catalogue storage means variable(s) being involved in execution of the transaction rule, such as a rate of return, and reading from another storage the value(s) of the variable(s);
manipulating the basis for the calculation(s) in accordance with the transaction rule thereby determining one or more amount to be credited and/or debited on one or more account; and
debiting and/or crediting the amounts determined in accordance with the transaction rule thereby effectuating a money transfer.

65. A method according to claim 64, further comprising the step of storing in a log file all debiting and crediting performed.

66. A method according to claim 64, wherein the check marking of an event is done after all crediting and/or debiting effectuated by the event has(have) been performed.

67. A method according to claim 59, further comprising storing in an event processing storage the begin time and end time of a time window after events occurred within said time window has been processed.

68. A method according to claim 27, further comprising reading product information from a product information storage storing information on product characteristics, such as percentage of the redistribution account to be transferred to the individual account, such as number of benefits to be transferred to be disbursed to the investor, parameters for cost calculations and the like.

69. A method according to claim 68, wherein some or all of the value(s) of the variable(s) of the basis of the calculations is(are) read from the product information storage.

70. A method according to claim 59, further comprising the step of reading from an investor agreement information storage information on the particular product assigned to the particular investor so that the event processing for a particular investor is based upon the product assigned to said particular investor, before initiation of event processing for a particular investor.

71. A method according to claim 27, wherein all transactions made on the individual account(s), the redistribution account(s) and the risk taker account are stored as records in one or more data storage.

72. A method according to claim 71, further comprising the step of determine the balances of the individual account(s), the redistribution account(s) and the risk taker account by summing all the transactions made on the accounts.

73. A method for improving the risk profile of investments made by an investor, the method comprising
depositing the investor's investments on an individual account,
transferring return of the individual investor account to a redistribution account,
transferring a proportion of the redistribution account to the individual investor account, the proportion being a function of the amount of the redistribution account, and transferring the amount of the redistribution account to a risk taker when a predetermined event occurs.
